(19) United States
(12) Patent Application Publication
(10) Pub. No.: US 2013/0016180 A1
(43) Pub. Date: Jan. 17, 2013

(54) IMAGE PROCESSING APPARATUS, METHOD, AND PROGRAM

(71) Applicant: Hiroaki ONO, KANAGAWA (JP)

(72) Inventor: Hiroaki ONO, KANAGAWA (JP)

(21) Appl. No.: 13/544,730

(22) Filed: Jul. 9, 2012

(30) Foreign Application Priority Data
Jul. 13, 2011 (JP) 2011-154627

(51) Int. Cl. H04N 7/00; H04N 5/225

(52) U.S. Cl. 348/36; 348/207.99; 348/E07.001

(57) ABSTRACT

There is provided an image processing apparatus including: a predicting unit calculating, based on a global motion vector found for a past picked-up image, predicted values of a global motion vector of a picked-up image to be processed; an effective region calculating unit deciding an effective region on the picked-up image based on the predicted values; a feature value calculating unit extracting feature values from the effective region on the picked-up image; a projecting unit calculating projected feature vectors by projecting the feature values onto an axis in a specified direction; and a global motion vector calculating unit calculating a global motion vector of the picked-up image to be processed by matching the projected feature vectors of the picked-up image to be processed and projected feature vectors of another picked-up image.

### BACKGROUND

The present disclosure relates to an image processing apparatus, method and program, and in more detail to an image processing apparatus, method and program capable of finding global motion vectors between images precisely and at high speed.

In the past, a technology for generating a panorama image by calculating global motion vectors between a plurality of still images that have been picked up consecutively and aligning and combining the still images based on such calculation results has been proposed.

Three main methods are known for estimating a global motion vector between two images.

The first of such known methods estimates global motion vectors on a feature point basis. In this method, as shown in FIG. 1, feature points are calculated for two images A11 and A12 that have been consecutively picked up.

In the example in FIG. 1, the circles on the image A11 and the squares on the image A12 indicate feature points. As examples, SIFT (Scale Invariant Feature Transform) and SURF (Speeded Up Robust Features) are known as representative examples of technologies for finding feature points, with such feature points being robust against magnification and reduction, rotation, and the like of a subject.

Next, the feature points on the image A11 and the feature points on the image A12 are associated. In FIG. 1, a feature point on the image A11 at the start of an arrow and a feature point on the image A12 at the end of the arrow are associated feature points. For example, when associating the feature points, by carrying out robust estimation such as RANSAC (Random Sample Consensus), it is possible to some extent to exclude outliers, such as a moving subject. Once the associating of the feature points on the image A11 and the image A12 has been confirmed, the associating results are used to calculate a global motion vector between the images.

The second known method estimates a global motion vector based on block matching. Motion estimation through block matching is widely used in digital video compression systems and the like.

In this method, as shown in FIG. 2, an image A13 is divided into a plurality of blocks and, for each of such blocks, a search is carried out for a region in an image A14 picked up following the image A13 that matches the block in the image A13.

That is, for the block BL11 in the image A13 for example, a search region TR11 that is centered on the same position in the image A14 as the block BL11 is decided. After this, a motion vector for the block BL11 is found by searching the respective regions within the search region TR11 for a region where the difference between the blocks (such as the sum of the absolute differences with the pixel values of the pixels inside the block BL11) is minimized. In addition, a global motion vector between the image A13 and the image A14 is found from the motion vectors of the respective blocks found in this way.

The third known method estimates global motion vectors according to integral projection. In this method, feature values for an image are projected on a specified axis and one-dimensional information (i.e., the feature values) that has been projected for each image is used to calculate a global motion vector between the images.

More specifically, a method is known which calculates a global motion vector at a low cost compared to normal block matching by setting the pixel values of respective pixels inside a block of an image as the feature values, integrally projecting such feature values in a row direction and a column direction, and carrying out a search using such projected values (see for example, E. Ogura, Y. Ikeda, Y. Iida, Y. Hosoya, M. Takashima, K. Yamashita “A Cost Effective Motion Estimation Processor LSI Using a Simple and Efficient Algorithm” IEEE Transactions on Consumer Electronics, Volume 41, Issue 3, 1995/8).

### SUMMARY

However, with the techniques described above, it has not been possible to calculate global motion vectors precisely and at high speed.

For example, although the first method is capable of calculating global motion vectors with high precision, the calculation cost is high. This means that although the first method is suited to software processing by a personal computer, such method is not suited to an apparatus, such as a mobile terminal apparatus or a digital camera, with inferior resources to a personal computer.

Also, the second method is very time-consuming when for example the calculation of a global motion vector between images with much higher resolution than video shot by a digital camera is realized by processing inside a digital camera. Although this is not a problem when a long processing time can be tolerated, it is difficult to calculate the global motion vectors at the same time as image pickup using the intervals between shutter operations during continuous shooting.

In addition, although the third method is capable of calculating global motion vectors at high speed compared to the first method and the second method given above, it is not possible to find the global motion vectors with high precision. In particular, to generate a panorama image using global motion vectors between images, it is desirable to calculate the global motion vectors with higher precision.

The present disclosure aims to calculate global motion vectors precisely and at high speed.

According to a first embodiment of the present disclosure, there is provided an image processing apparatus including a predicting unit calculating, based on a global motion vector found for a past picked-up image, predicted values of a global motion vector of a picked-up image to be processed, an effective region calculating unit deciding an effective region on the picked-up image based on the predicted values, a feature value calculating unit extracting feature values from the effective region on the picked-up image, a projecting unit calculating projected feature vectors by projecting the feature values onto an axis in a specified direction, and a global motion vector calculating unit calculating a global motion vector of the picked-up image to be processed by matching the projected feature vectors of the picked-up image to be processed and projected feature vectors of another picked-up image.

The effective region calculating unit may decide the effective region based on the predicted values and one of distortion information for an optical system used to pick up the picked-up images and a region of a specified subject in the picked-up images.

The feature value calculating unit may calculate the feature values based on pixels aligned in the specified direction on the picked-up images.

The feature value calculating unit may calculate the feature values based on gradient information of pixels in the picked-up images.

The feature value calculating unit may calculate the feature values based on color information of the picked-up images.

The projecting unit may project the feature values onto two axes that are respectively perpendicular and calculates the projected feature vectors for each axis

The image processing apparatus may further include a panorama combining unit combining the picked-up images based on the global motion vectors to generate a panorama image.

The image processing apparatus may further include an image stabilization unit carrying out image stabilization on the picked-up images based on the global motion vector.

According to the first embodiment of the present disclosure, there is provided an image processing method or a program causing a computer to carry out processing including calculating, based on a global motion vector found for a past picked-up image, predicted values of a global motion vector of a picked-up image to be processed, deciding an effective region on the picked-up images based on the predicted values, extracting feature values from the effective region on the picked-up images, calculating projected feature vectors by projecting the feature values onto an axis in a specified direction, and calculating a global motion vector of the picked-up image to be processed by matching the projected feature vectors of the picked-up image to be processed and projected feature vectors of another picked-up image.

According to the first embodiment of the present disclosure, based on a global motion vector found for a past picked-up image, predicted values of a global motion vector of a picked-up image to be processed may be calculated, an effective region on the picked-up images based on the predicted values may be decided, feature values from the effective region on the picked-up images may be extracted, projected feature vectors by projecting the feature values onto an axis in a specified direction may be calculated, and a global motion vector of the picked-up image to be processed by matching the projected feature vectors of the picked-up image to be processed and projected feature vectors of another picked-up image may be calculated.

According to a second embodiment of the present disclosure, there is provided an image processing apparatus including an effective region calculating unit deciding an effective region on a picked-up image based on one of distortion information for an optical system used to pick up the picked-up image and a region of a specified subject in the picked-up image, a feature value calculating unit extracting feature values from the effective region on the picked-up image, a projecting unit calculating projected feature vectors by projecting the feature values onto an axis in a specified direction, and a global motion vector calculating unit calculating a global motion vector of the picked-up image to be processed by matching the projected feature vectors of the picked-up image to be processed and projected feature vectors of another picked-up image.

According to the second embodiment of the present disclosure, there is provided an image processing method or a program causing a computer to carry out processing including deciding an effective region on a picked-up image based on one of distortion information for an optical system used to pick up the picked-up image and a region of a specified subject in the picked-up image, extracting feature values from the effective region on the picked-up image, calculating projected feature vectors by projecting the feature values onto an axis in a specified direction, and calculating a global motion vector of the picked-up image to be processed by matching the projected feature vectors of the picked-up image to be processed and projected feature vectors of another picked-up image.

According to the second embodiment of the present disclosure, an effective region on a picked-up image based on one of distortion information for an optical system used to pick up the picked-up image and a region of a specified subject in the picked-up image may be decided, feature values from the effective region on the picked-up image may be extracted, projected feature vectors by projecting the feature values onto an axis in a specified direction may be calculated, and a global motion vector of the picked-up image to be processed by matching the projected feature vectors of the picked-up image to be processed and projected feature vectors of another picked-up image may be calculated.

According to the embodiments of the present disclosure described above, it is possible to calculate global motion vectors precisely and at high speed.

### BRIEF DESCRIPTION OF THE DRAWINGS

FIG. 1 is a diagram useful in explaining calculation of a global motion vector using feature points;

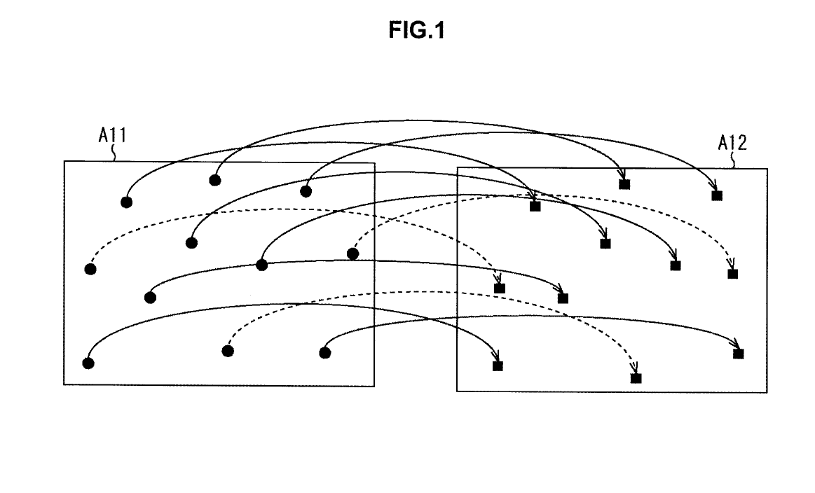

FIG. 2 is a diagram useful in explaining calculation of a global motion vector according to block matching;

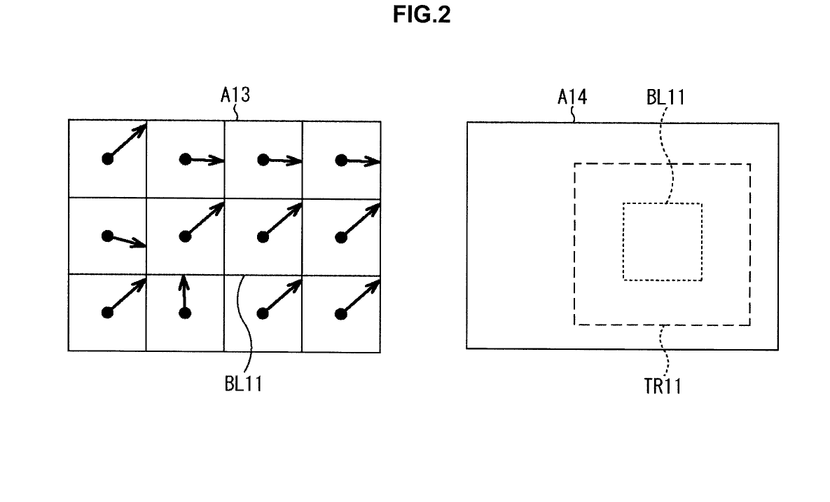

FIG. 3 is a diagram showing an example configuration of an embodiment of an image pickup apparatus;

FIG. 4 is a diagram showing an example configuration of an image processing circuit;

FIG. 5 is a flowchart useful in explaining a global motion vector calculating process;

FIG. 6 is a diagram useful in explaining projection of local feature values;

FIG. 7 is a diagram useful in explaining a global motion vector;

FIG. 8 is a diagram showing another example configuration of an image processing circuit;

FIG. 9 is a flowchart useful in explaining a global motion vector calculating process;

FIG. 10 is a diagram useful in explaining prediction of a global motion vector;

FIG. 11 is a diagram useful in explaining an effective region;

FIG. 12 is a diagram useful in explaining the effect of setting an effective region;

FIG. 13 is a diagram showing another example configuration of an image processing circuit;

FIG. 14 is a flowchart useful in explaining a global motion vector calculating process;

FIG. 15 is a diagram useful in explaining an effective region;

FIG. 16 is a diagram showing another example configuration of an image processing circuit;

FIG. 17 is a flowchart useful in explaining a global motion vector calculating process;

FIG. 18 is a diagram showing another example configuration of an image processing circuit;

FIG. 19 is a flowchart useful in explaining a global motion vector calculating process;

FIG. 20 is a diagram useful in explaining generation of a panorama image;

FIG. 21 is a diagram showing another example configuration of an image processing circuit;

FIG. 22 is a flowchart useful in explaining a global motion vector calculating process;

FIG. 23 is a diagram useful in explaining how connecting positions of picked-up images are decided;

FIG. 24 is a diagram useful in explaining the combining of picked-up images;

FIG. 25 is a diagram useful in explaining trimming of a panorama image;

FIG. 26 is a diagram showing another example configuration of an image processing circuit;

FIG. 27 is a flowchart useful in explaining a global motion vector calculating process; and

FIG. 28 is a diagram showing an example configuration of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

### Example Configuration of Image Pickup Apparatus

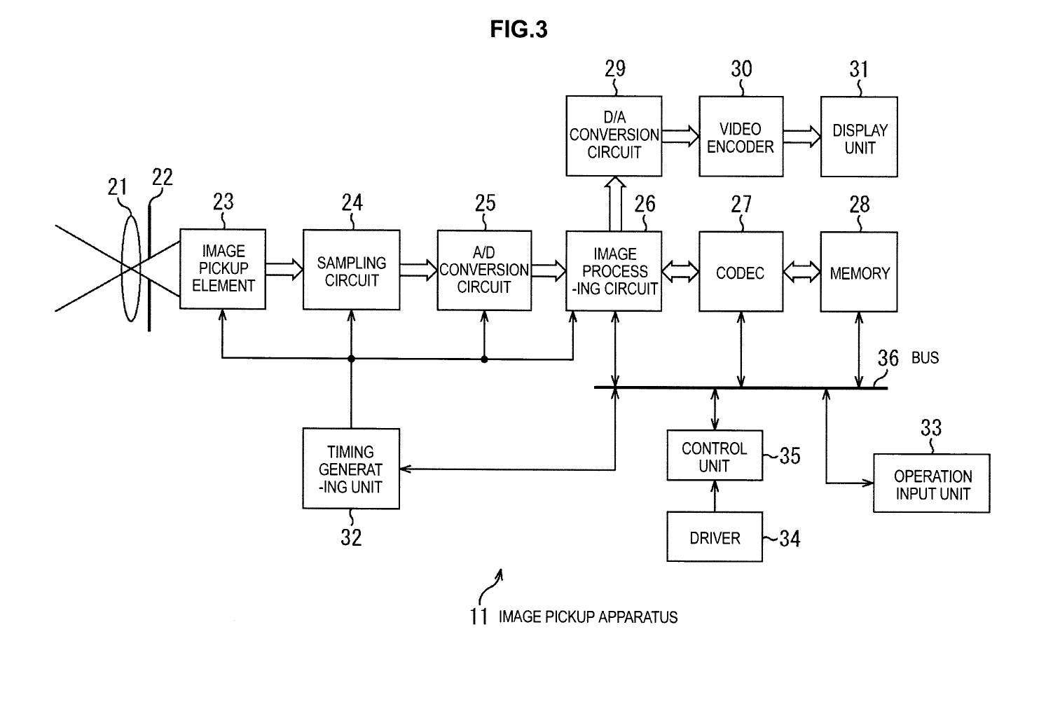

FIG. 3 is a diagram showing an example configuration of one embodiment of an image pickup apparatus according to the present disclosure.

The configuration of this image pickup apparatus 11 can be roughly classified into an optical system, a signal processing system, a recording system, a display system, and a control system.

That is, the optical system includes a lens 21 that focuses image light of a subject, an aperture 22 that adjusts the amount of image light from the lens 21, and an image pickup element 23 that carries out photoelectrical conversion on the focused image light to convert the light to an electrical signal. The image pickup element 23 is composed for example of a CCD (Charge Coupled Device) image sensor or a CMOS (Complementary Metal Oxide Semiconductor) image sensor.

The signal processing system includes a sampling circuit 24, an A/D (Analog/Digital) conversion circuit 25, and an image processing circuit 26. The sampling circuit 24 is realized by a correlated double sampling (CDS) circuit, for example, and samples an electrical signal from the image pickup element 23 to generate an analog signal. By doing so, noise generated by the image pickup element 23 is reduced. The analog signal obtained by the sampling circuit 24 is an image signal for displaying the picked-up image of the subject.

The A/D conversion circuit 25 converts the analog signal supplied from the sampling circuit 24 to a digital signal and supplies the digital signal to the image processing circuit 26. The image processing circuit 26 carries out specified image processing on the digital signal inputted from the A/D conversion circuit 25.

The recording system includes a codec (coder/decoder) 27 that encodes or decodes an image signal and a memory 28 that records an image signal. The codec 27 encodes an image signal, which is a digital signal that has been processed by the image processing circuit 26, and records the encoded signal in the memory 28, and/or reads out and decodes an image signal from the memory 28 and supplies the decoded signal to the image processing circuit 26.

The display system includes a D/A (Digital/Analog) conversion circuit 29, a video encoder 30, and a display unit 31.

The D/A conversion circuit 29 converts the image signal processed by the image processing circuit 26 to analog and supplies the analog signal to the video encoder 30, and the video encoder 30 encodes the image signal from the D/A conversion circuit 29 to a video signal of a compatible format for the display unit 31. The display unit 31 is realized by an LCD (Liquid Crystal Display), for example, and based on the video signal obtained by encoding by the video encoder 30, displays images corresponding to the video signal. The display unit 31 also functions as a finder when picking up images of a subject.

The control system includes a timing generating unit 32, an operation input unit 33, a driver 34, and a control unit 35. The image processing circuit 26, the codec 27, the memory 28, the timing generating unit 32, the operation input unit 33, and the control unit 35 are connected to one another via a bus 36.

The timing generating unit 32 controls the timing of operation by the image pickup element 23, the sampling circuit 24, the A/D conversion circuit 25, and the image processing circuit 26. The operation input unit 33 is composed of buttons, switches, and the like, receives shutter operations and the inputting of other commands from the user, and supplies a signal in accordance with an operation made by the user to the control unit 35.

Specified peripheral devices are connected to the driver 34 and the driver 34 drives the connected peripheral devices. For example, the driver 34 reads data from a recording medium such as a magnetic disk, an optical disc, a magneto-optical disc, or a semiconductor memory connected as a peripheral device and supplies the data to the control unit 35.

The control unit 35 controls the entire image pickup apparatus 11. For example, the control unit 35 reads out, via the driver 34, a control program from a recording medium connected to the driver 34 and controls the operation of the entire image pickup apparatus 11 based on the control program and commands and the like from the operation input unit 33.

Next, the operation of the image pickup apparatus 11 will be described.

In the image pickup apparatus 11, light from the subject, that is, image light of the subject becomes incident via the lens 21 and the aperture 22 on the image pickup element 23, and is subjected to photoelectric conversion by the image pickup element 23 to produce an electrical signal. After a noise component of the electrical signal obtained by the image pickup element 23 is removed by the sampling circuit 24 and the signal has been converted to digital by the A/D conversion circuit 25, the signal is temporarily stored in an image memory, not shown, incorporated in the image processing circuit 26.

Note that in a normal state, that is, a state before a shutter operation is carried out, by controlling timing for the signal processing system using the timing generating unit 32, the image signal from the A/D conversion circuit 25 is continuously overwritten into the image memory of the image processing circuit 26 at a certain frame rate. The image signal inside the image memory of the image processing circuit 26 is converted by the D/A conversion circuit 29 from a digital signal to an analog signal, is converted by the video encoder 30 to a video signal, and images corresponding to the video signal are displayed on the display unit 31.

In this case, the display unit 31 also functions as a finder of the image pickup apparatus 11. While viewing images displayed on the display unit 31, the user decides the composition, and then presses a shutter button as the operation input unit 33 to indicate image pickup. When the shutter button is pressed, based on the signal from the operation input unit 33, the control unit 35 instructs the timing generating unit 32 to hold the image signal immediately after the shutter button was pressed. By doing so, the signal processing system is controlled so that the image signal is not overwritten in the image memory of the image processing circuit 26.

After this, the image signal held in the image memory of the image processing circuit 26 is encoded by the codec 27 and recorded in the memory 28. As a result of the operation of the image pickup apparatus 11 described above, the acquisition of the image signal of one image is completed.

### Configuration of Image Processing Circuit

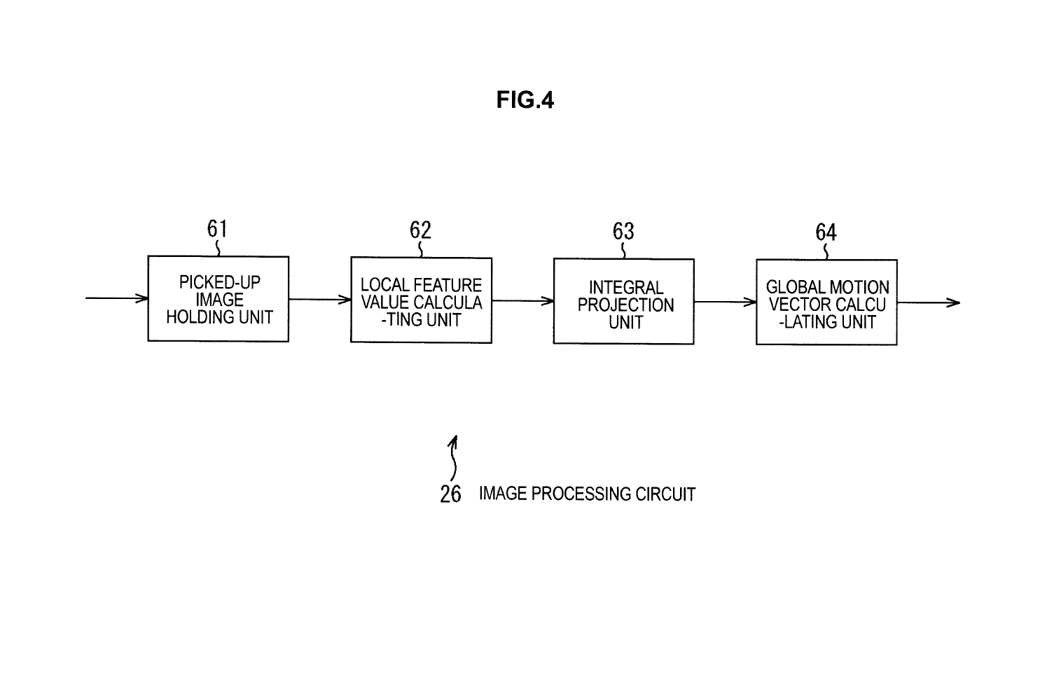

In more detail, the image processing circuit 26 in FIG. 3 is configured as shown in FIG. 4.

That is, the image processing circuit 26 includes a picked-up image holding unit 61, a local feature value calculating unit 62, an integral projection unit 63, and a global motion vector calculating unit 64.

An image of a subject (hereinafter “subject image”) picked up by the image pickup apparatus 11 is supplied to the picked-up image holding unit 61 and the picked-up image holding unit 61 holds a plurality of picked-up images that have been supplied. The picked-up images supplied to the picked-up image holding unit 61 are images consecutively picked-up in a state where the image pickup apparatus 11 is moving (sweeping) in a specified direction. During pickup of the picked-up images, the image pickup apparatus 11 moves so that the same subject is included in two picked-up images that are consecutively picked up.

Note that out of the images that are consecutively picked up, the t^{th} image to be picked up is referred to as the “picked-up image of frame t”.

The local feature value calculating unit 62 extracts local feature values from the picked-up images held in the picked-up image holding unit 61 and supplies the local feature values to the integral projection unit 63. The integral projection unit 63 projects the local feature values supplied from the local feature value calculating unit 62 onto an axis in a specified direction and supplies the projected values onto the global motion vector calculating unit 64.

By matching the projected local feature values of the picked-up images of consecutive frames supplied from the integral projection unit 63, the global motion vector calculating unit 64 calculates and outputs a global motion vector for the picked-up images. Here, a global motion vector for a picked-up image is a motion vector for the entire picked-up image, and shows the positional relationship of picked-up images when two picked-up images have been overlaid so that the same subject coincides. In other words, global motion vectors are capable of showing movement of the image pickup apparatus 11 relative to a non-moving subject, such as a background, during pickup of the picked-up images.

### Description of Global Motion Vector Calculating Process

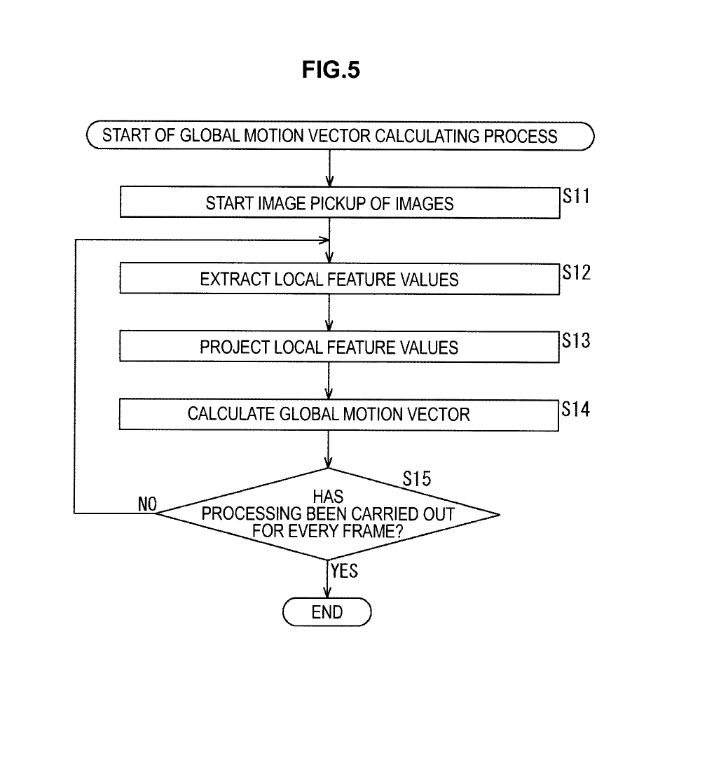

However, when the user has operated the operation input unit 33 to indicate processing, such as generation of a panorama image, which involves calculation of global motion vectors, the image pickup apparatus 11 starts a global motion vector calculating process that picks up the picked-up images and calculates the global motion vectors. Next, the global motion vector calculating process carried out by the image pickup apparatus 11 will be described with reference to the flowchart in FIG. 5.

In step S11, the image pickup apparatus 11 starts pickup of the picked-up images. That is, when processing is started, the user causes the image pickup apparatus 11 to consecutively pick up a plurality of picked-up images while sweeping the image pickup apparatus 11 in a specified direction.

Since light from the subject is incident on the image pickup element 23 via the lens 21 and the aperture 22, the image pickup element 23 carries out photoelectric conversion on the incident light to pick up images. The obtained picked-up images (image signal) are supplied to the memory 28 from the image pickup element 23 via the elements from the sampling circuit 24 to the codec 27 and recorded in the memory 28. When doing so, the picked-up images are encoded by the codec 27. When the picked-up images are recorded in the memory 28, frame numbers are assigned in the image pickup order to the respective images.

When the plurality of picked-up images have been successively recorded in the memory 28, the picked-up images are read out from the memory 28 by the codec 27 and decoded. The decoded images are supplied to the picked-up image holding unit 61 of the image processing circuit 26 and held.

Note that it is also possible for the picked-up images obtained by image pickup to be supplied directly to the picked-up image holding unit 61 without being recorded in the memory 28. Here, a “picked-up image” may be a single still image that has been picked up or may be an image of one frame that composes moving images that have been picked up.

In step S12, the local feature value calculating unit 62 acquires the picked-up images of two consecutive frames including the frame to be processed from the picked-up image holding unit 61 and extracts the local feature values from such picked-up images.

For example, directions that are perpendicular on the picked-up images are set as the x direction and the y direction and the pixel value of a pixel at coordinates (x,y) on a picked-up image in the xy coordinate system with the x direction and y direction as axes is set as v(x,y). In this case, the local feature value calculating unit 62 sets the pixel values v(x,y) of the respective pixels in the picked-up images without amendment as the local feature values.

Note that the x direction is also referred to as the “horizontal direction” and the y direction is also referred to as the “vertical direction”. Also, the local feature values may be pixel values that are color information (for example, information on the respective colors R, G, and B) or may be luminance values of the pixels.

It is also possible to calculate the local feature values based on gradient information for the pixels in the picked-up images, such as absolute differences between pixels in the picked-up images and or square differences between pixels.

That is, as one example, it is possible to find the absolute difference with a pixel that is adjacent in the horizontal direction as the local feature value in the horizontal direction of a pixel at the coordinates (x,y) on the picked-up images, and the absolute difference with a pixel that is adjacent in the vertical direction as the local feature value in the vertical direction. In this case, as examples |v(x+1,y)−v(x,y)| is calculated as the local feature value in the horizontal direction and |v(x,y+1)−v(x,y)| is calculated as the local feature value in the vertical direction.

As the horizontal local feature value and the vertical local feature value, it is also possible to calculate the square difference with a pixel adjacent in the horizontal direction on the picked-up images and the square difference with a pixel adjacent in the vertical direction on the picked-up images. That is, in this case, (v(x+1,y)−v(x,y))² is calculated as the local feature value in the horizontal direction and (v(x,y+1)−v(x,y))² is calculated as the local feature value in the vertical direction.

After calculating the local feature values of the respective pixels in the picked-up images, the local feature value calculating unit 62 supplies the calculated local feature values to the integral projection unit 63.

In step S13, the integral projection unit 63 projects the local feature values supplied from the local feature value calculating unit 62 onto an axis in a specified direction to calculate projected feature vectors and supplies the projected feature vectors to the global motion vector calculating unit 64.

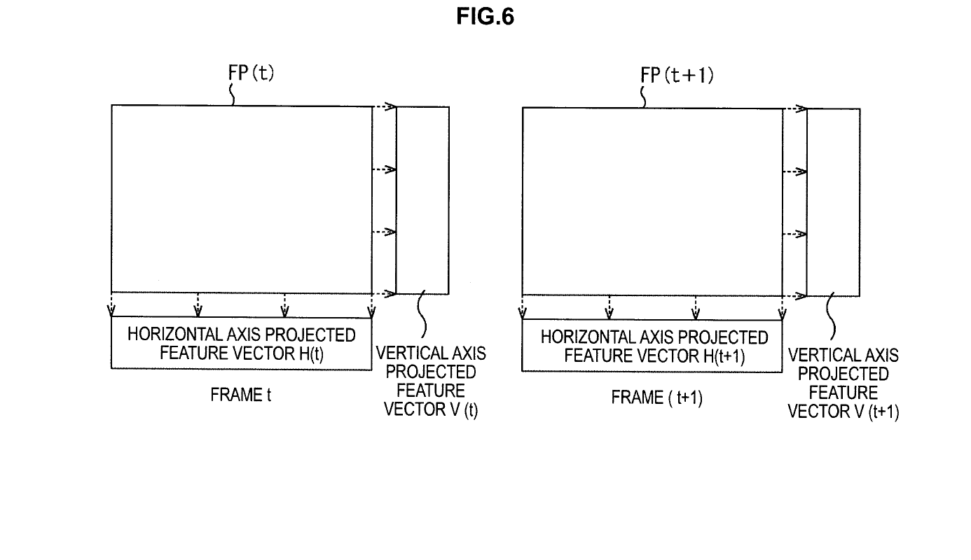

More specifically, as shown in FIG. 6 for example, assume that local feature values are extracted from the picked-up image FP(t+1) of a frame (t+1) to be processed and a picked-up image FP(t) of the frame t immediately before the frame (t+1). Note that in FIG. 6, the horizontal direction and the vertical direction show the x direction (horizontal direction) and the y direction (vertical direction).

The integral projection unit 63 projects the local feature values in the horizontal direction found for the respective pixels of the picked-up image FP(t) onto an axis in the horizontal direction (hereinafter simply “horizontal axis”) and, by finding a sum of the local feature values projected onto the same position on the horizontal axis, calculates a horizontal axis projected feature vector H(t).

Here, it is assumed that the picked-up image FP(t) is an image composed of a total of X by Y pixels with X pixels in the horizontal direction and Y pixels in the vertical direction. In this case, the integral projection unit 63 calculates, for each position x in the horizontal direction (x direction), an integral projection value ph(x) that is an element of the horizontal axis projected feature vector H(t) and sets a vector composed of the X integral projection values ph(x) calculated for the respective positions x in the horizontal direction as the horizontal axis projected feature vector H(t). Each integral projection value ph(x) is the sum of the local feature values in the horizontal direction of pixels in the picked-up image FP(t) for which the x coordinate is the same.

In the same way, the integral projection unit 63 projects the local feature values in the vertical direction found for the respective pixels of the picked-up image FP(t) onto an axis in the vertical direction (hereinafter simply “vertical axis”) and, by finding a sum of the local feature values projected onto the same position on the vertical axis, calculates a vertical axis projected feature vector V(t). That is, the integral projection unit 63 calculates, for each position y in the vertical direction (y direction), an integral projection value pv(y) that is an element of the vertical axis projected feature vector V(t) and sets a vector composed of the Y integral projection values pv(y) calculated for the respective positions y in the vertical direction as the vertical axis projected feature vector V(t). Each integral projection value pv(y) is the sum of the local feature values in the vertical direction of pixels in the picked-up image FP(t) for which the y coordinate is the same.

Accordingly, when the pixel values (x,y) of the pixels are used without amendment as the local feature values, for example, the integral projection values ph(x) that construct the horizontal axis projected feature vector H(t) and the integral projection values pv(y) that construct the vertical axis projected feature vector V(t) are respectively expressed by Equations (1) and (2) below. Note that in this case, the local feature values in the horizontal direction and the vertical direction are both the pixel values v(x, y) of pixels.

$$\begin{matrix}p h ( x ) = {\sum }_{y} v ( x , y ) & ( 1 ) \\ pv ( y ) = {\sum }_{x} v ( x , y ) & ( 2 )\end{matrix}$$

When for example, the absolute difference with a pixel adjacent in the horizontal direction and the absolute difference with a pixel adjacent in the vertical direction are respectively found as the local feature values in the horizontal direction and the vertical direction, the integral projection values ph(y) and integral projection values pv(y) are respectively expressed by Equations (3) and (4) below.

$$\begin{matrix}p h ( x ) = {\sum }_{y} \vert v ( x + 1 , y ) - v ( x , y ) \vert & ( 3 ) \\ pv ( y ) = {\sum }_{x} \vert v ( x , y + 1 ) - v ( x , y ) \vert & ( 4 )\end{matrix}$$

In addition, when for example the square difference with a pixel adjacent in the horizontal direction and the square difference with a pixel adjacent in the vertical direction are respectively found as the local feature values in the horizontal direction and the vertical direction, the integral projection values ph(y) and integral projection values pv(y) are respectively expressed by Equations (5) and (6) below.

$$\begin{matrix}p h ( x ) = {\sum }_{y} {( v ( x + 1 , y ) - v ( x , y ) )}^{2} & ( 5 ) \\ pv ( y ) = {\sum }_{x} {( v ( x , y + 1 ) - v ( x , y ) )}^{2} & ( 6 )\end{matrix}$$

On calculating the horizontal axis projected feature vector H(t) and the vertical axis projected feature vector V(t) of the picked-up image FP(t) in this way, the integral projection unit 63 also calculates the horizontal axis projected feature vector H(t+1) and the vertical axis projected feature vector V(t+1) of the picked-up image FP(t+1) using the same calculations.

Note that although an example where the local feature values are projected onto the horizontal axis and the vertical axis that are perpendicular has been described with reference to FIG. 6, the axes used for projection are not limited to the horizontal direction and the vertical direction and may be any directions. Also, the number of axes for projecting the local feature values is not limited to two and may be any number.

Hereinafter, when it is unnecessary to distinguish between the horizontal axis projected feature vector and the vertical axis projected feature vector, such vectors are referred to simply as the “projected feature vectors”.

Returning to the description of the flowchart in FIG. 5, once the projected feature vectors have been calculated, in step S14, the global motion vector calculating unit 64 calculates a global motion vector of a picked-up image based on the projected feature vectors supplied from the integral projection unit 63 and outputs the calculated global motion vectors.

More specifically, as one example the global motion vector calculating unit 64 carries out matching for the horizontal axis projected feature vector H(t) and the horizontal axis projected feature vector H(t+1) and finds the component (x component) in the horizontal direction of the global motion vector.

That is, the global motion vector calculating unit 64 aligns the horizontal axis projected feature vectors in the y direction so that the integral projection values ph(x) with the same x coordinate in the horizontal axis projected feature vector H(t) and the horizontal axis projected feature vector H(t+1) are aligned in the y direction. After this, while shifting the horizontal axis projected feature vector H(t+1) in the x direction relative to the horizontal axis projected feature vector H(t), the global motion vector calculating unit 64 finds the average value of the absolute differences between the integral projection values ph(x) at the same positions in the x direction for the parts where the horizontal axis projected feature vectors overlap in the y direction.

For example, assume that the horizontal axis projected feature vector H(t+1) has been shifted (moved in parallel) by a distance S in the x direction relative to the horizontal axis projected feature vector H(t). In this case, the average value of the absolute differences between the integral projection values ph(x) of the horizontal axis projected feature vector H(t) and the integral projection values ph(x−S) of the horizontal axis projected feature vector H(t+1) is found.

After this, the global motion vector calculating unit 64 finds the shift distance S that produces the smallest average value of the absolute differences between the integral projection values ph(x) and sets the obtained shift distance S as the horizontal direction component (x component) of the global motion vector.

Also, by carrying out the same calculations as for the horizontal direction, the global motion vector calculating unit 64 carries out matching for the vertical axis projected feature vector V(t) and the vertical axis projected feature vector V(t+1) and finds the vertical direction component (y component) of the global motion vector. A vector composed of the x component and the y component obtained in this way is set as the global motion vector.

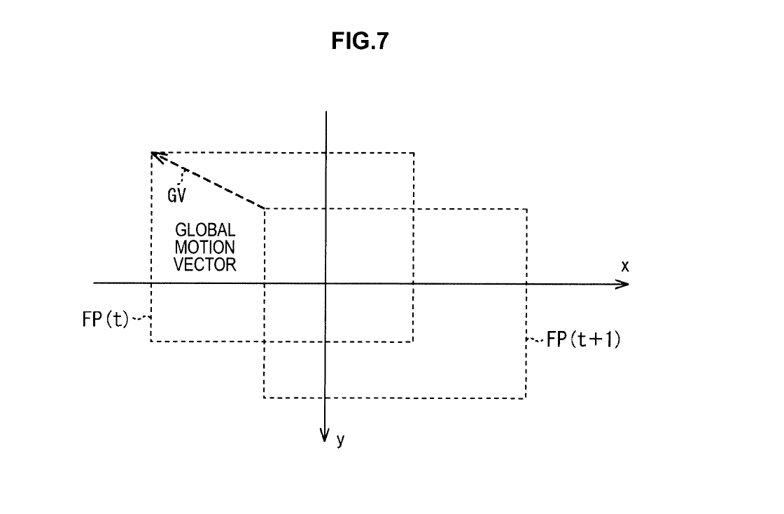

By doing so, as one example the global motion vector GV shown in FIG. 7 is obtained. Note that in FIG. 7, the horizontal direction and the vertical direction show the x direction and the y direction.

In the example in FIG. 7, the images are aligned so that the same subject in the picked-up image FP(t) of the frame t and the picked-up image FP(t+1) of the frame t+1 coincide. Also, a vector GV that has the upper left vertex in the picked-up image FP(t+1) as the start point and the upper left vertex in the picked-up image FP(t) as the end point is set as the global motion vector of the frame t+1. This vector GV shows the relative positional relationship between the picked-up image FP(t) and the picked-up image FP(t+1).

Returning to the description of the flowchart in FIG. 5, in step S15, the image processing circuit 26 determines whether processing has been carried out for the picked-up images of every frame. As one example, if a global motion vector has been calculated for the picked-up image of every frame, it is determined that every frame has been processed.

If it has been determined in step S15 that processing is yet to be carried out for every frame, the processing returns to step S12 and the processing described earlier is repeated. That is, the next frame is set as the frame to be processed and a global motion vector for the picked-up image of such frame is calculated.

On the other hand, if it has been determined in step S 5 that processing has been carried out for every frame, the image processing circuit 26 stops the processing of the various units and the global motion vector calculating process ends.

In this way, the image pickup apparatus 11 finds global motion vectors by projecting the local feature values of picked-up images onto axes in specified directions and matching the projected feature vectors obtained as a result. By projecting the local feature values onto axes in specified directions in this way, it is possible to reduce the amount of information (feature values) used in the matching process, so that compared to typical block matching or the like, it is possible to obtain the global motion vectors at a higher speed.

Note that although examples have been described above where the pixel values of pixels, the absolute differences between pixels, or the square differences between pixels are found as the local feature values, the list “square differences, absolute differences, pixel values” shows such values as local feature values in descending order of effectiveness in improving the matching precision. However, the list “pixel values of pixels, absolute differences, square differences” shows such values in order of increasing calculation cost for the matching process.

### Second Embodiment

### Configuration of Image Processing Circuit

Although the extraction of local feature values from an entire picked-up image has been described above, it is also possible to extract local feature values from only a region (hereinafter referred to as the “effective region”) that is useful for calculating the global motion vector of the picked-up image.

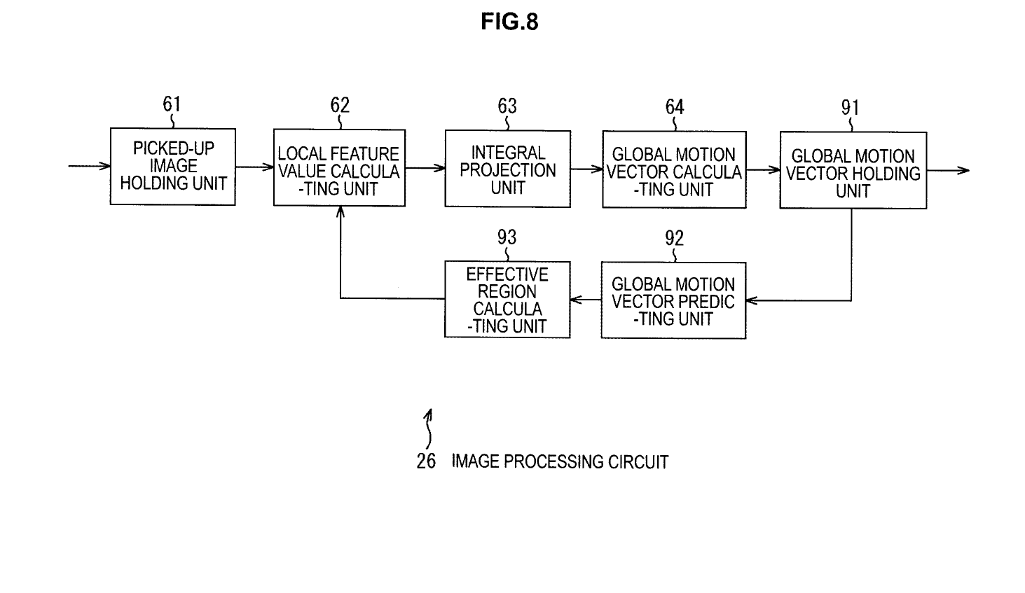

In such case, the image processing circuit 26 in FIG. 3 is configured as shown in FIG. 8. Note that parts in FIG. 8 that correspond to the case shown in FIG. 4 have been assigned the same reference numerals and description thereof is omitted as appropriate.

The image processing circuit 26 in FIG. 8 includes the picked-up image holding unit 61, the local feature value calculating unit 62, the integral projection unit 63, the global motion vector calculating unit 64, a global motion vector holding unit 91, a global motion vector predicting unit 92, and an effective region calculating unit 93.

The configuration of the image processing circuit 26 in FIG. 8 differs to the image processing circuit 26 in FIG. 4 by newly including the global motion vector holding unit 91, the global motion vector predicting unit 92, and the effective region calculating unit 93 and is otherwise the same as the image processing circuit 26 in FIG. 4.

The global motion vector holding unit 91 holds global motion vectors supplied from the global motion vector calculating unit 64 and outputs global motion vectors to component elements provided downstream. The global motion vector holding unit 91 also supplies the held global motion vectors as necessary to the global motion vector predicting unit 92.

The global motion vector predicting unit 92 predicts the global motion vector of the frame to be processed based on the global motion vectors of past frames supplied from the global motion vector holding unit 91 and supplies the predicted global motion vector to the effective region calculating unit 93.

The effective region calculating unit 93 decides an effective region on a picked-up image based on the predicted values of the global motion vector supplied from the global motion vector predicting unit 92 and supplies the effective region to the local feature value calculating unit 62. Also, out of the regions on a picked-up image acquired from the picked-up image holding unit 61, the local feature value calculating unit 62 extracts local feature values from the effective region supplied from the effective region calculating unit 93 and supplies the local feature values to the integral projection unit 63.

### Description of Global Motion Vector Calculating Process

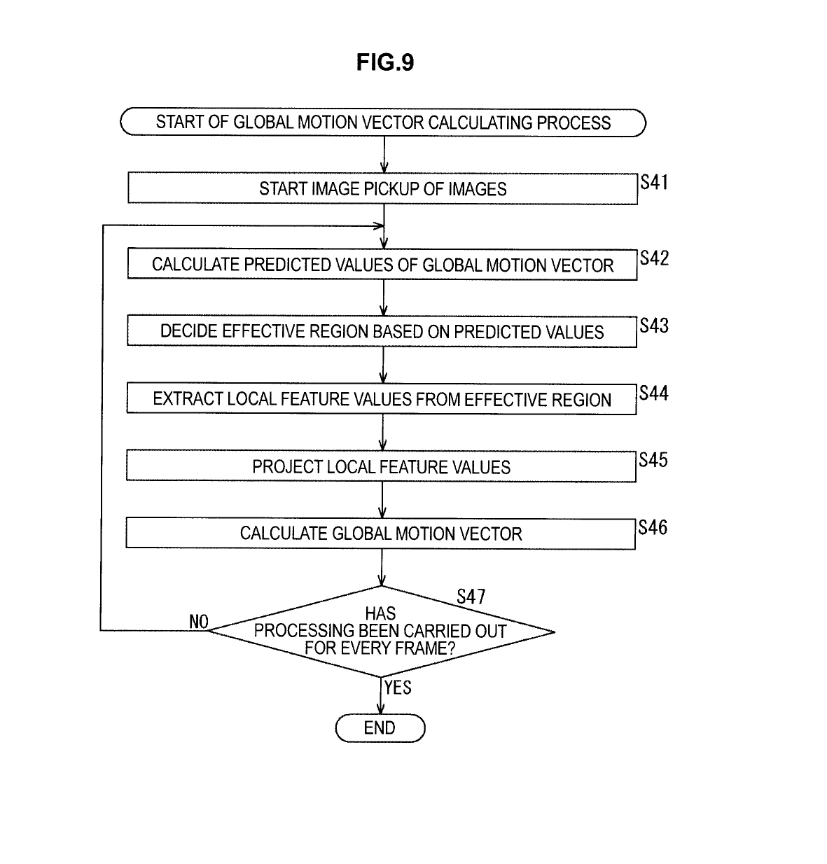

Next, the global motion vector calculating process for the case where the image processing circuit 26 of the image pickup apparatus 11 is configured as shown in FIG. 8 will be described with reference to the flowchart in FIG. 9. Note that since the processing in step S41 is the same as the processing in step S11 in FIG. 5, description thereof is omitted.

In step S42, the global motion vector predicting unit 92 calculates predicted values for the global motion vector of the frame to be processed based on the global motion vectors supplied from the global motion vector holding unit 91 and supplies the predicted values to the effective region calculating unit 93.

For example, the global motion vector predicting unit 92 calculates predicted values of the global motion vector of the frame to be processed by carrying out zero-order and/or first-order extrapolation of the global motion vectors of past frames.

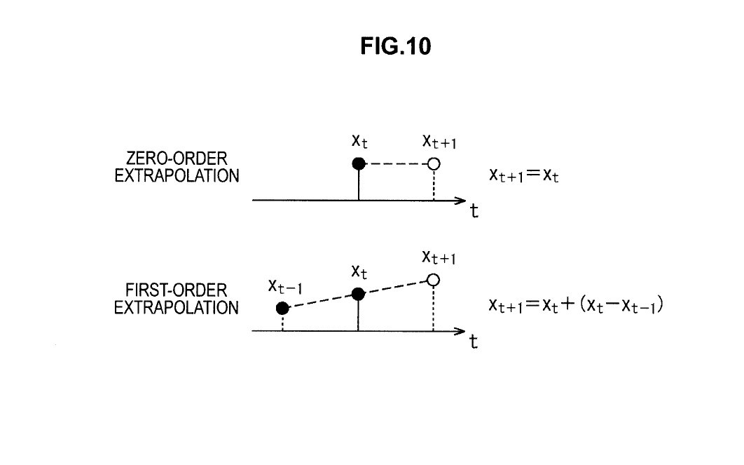

More specifically, the predicted value of the x component of the global motion vector of the frame (t+1) to be processed is expressed as xₜ₊₁ and the x component of the global motion vector of the frame t is expressed as xₜ. When doing so, if xₜ₊₁ is found by zero-order extrapolation, as shown at the top in FIG. 10 for example, xₜ of the immediately preceding frame (time) is set without amendment as xₜ₊₁. Note that in FIG. 10, the horizontal direction shows time and the vertical direction shows the magnitude of the x component of a global motion vector.

In the same way as the x component, the y component of the global motion vector of the frame t that immediately precedes the frame (t+1) to be processed is set without amendment as the predicted value of the y component of the global motion vector of the frame (t+1).

In addition, if the x component of the global motion vector of the frame (t−1) that is two frames before the frame (t+1) to be processed is expressed as xₜ₋₁ and xₜ₊₁ is found by first-order extrapolation, the predicted value xₜ₊₁ is calculated by calculating xₜ₊₁=xₜ+(xₜ−xₜ₋₁) as shown at the bottom in FIG. 10. In this case also, by carrying out the same calculation as for the x component, the predicted value of the y component of the global motion vector of the frame (t+1) is found.

In step S43, the effective region calculating unit 93 decides the effective region on the picked-up image based on the predicted values of the global motion vector supplied from the global motion vector predicting unit 92 and supplies the decided effective region to the local feature value calculating unit 62.

In step S44, the local feature value calculating unit 62 extracts the local feature values from the effective region supplied from the effective region calculating unit 93 out of the regions on the picked-up image acquired from the picked-up image holding unit 61 and supplies the local feature values to the integral projection unit 63.

In step S45, the integral projection unit 63 projects the local feature values supplied from the local feature value calculating unit 62 onto axes in specified directions to calculate projected feature vectors and supplies the projected feature vectors to the global motion vector calculating unit 64.

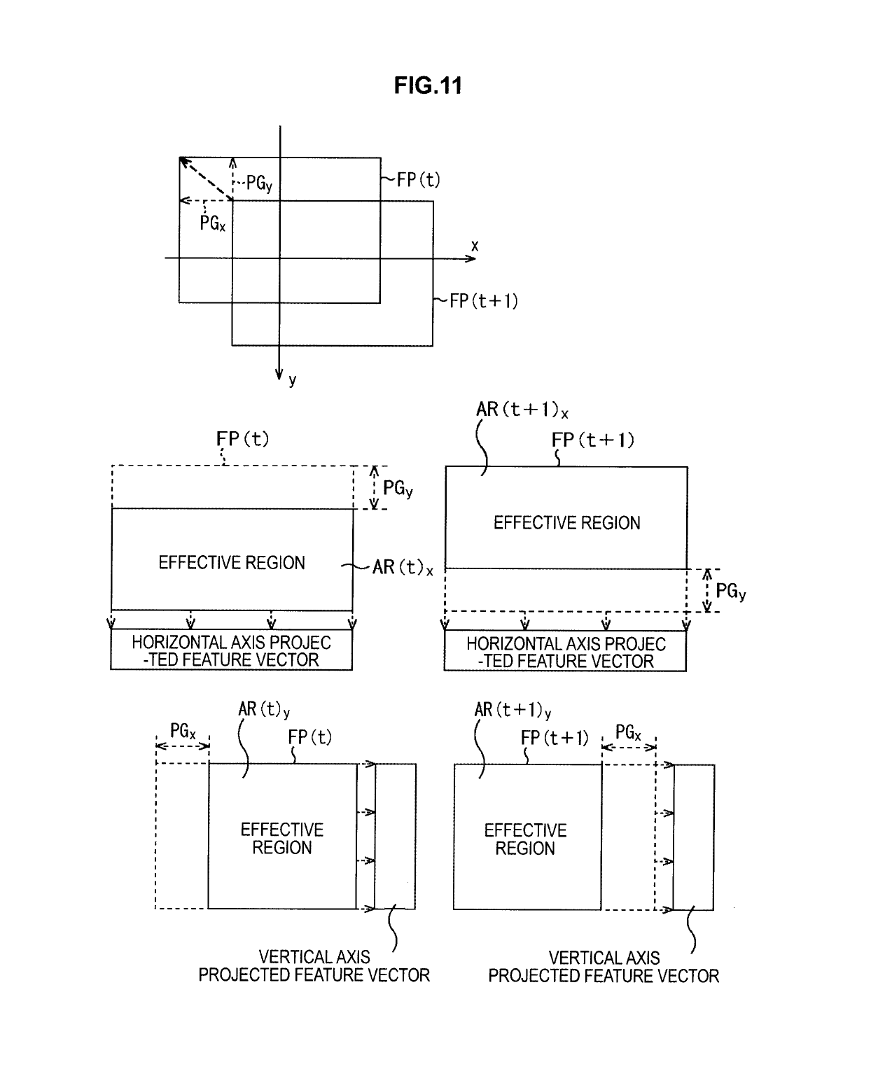

For example, as shown at the top in FIG. 11, predicted values of the x component and the y component of the global motion vector of the frame (t+1) to be processed are expressed as PGₓ and PG_{y}. Note that in FIG. 11, the horizontal direction and the vertical direction respectively show the x direction and the y direction.

At the top of FIG. 11, the picked-up image FP(t) of the frame t and the picked-up image FP(t+1) of the frame (t+1) are shown, and the arrow between the picked-up images shows the global motion vector obtained by prediction.

If the predicted value PGₓ of the x component and the predicted value PG_{y} of the y component of the global motion vector have been obtained in this way, the effective region calculating unit 93 determines the effective region for each projected feature vector for the picked-up images as shown in the middle and at the bottom in FIG. 11.

That is, as shown on the left in the middle of FIG. 11, the effective region calculating unit 93 sets the effective region AR(t)ₓ obtained by excluding a region from the upper edge of the picked-up image FP(t) to a position separated by the magnitude of the predicted value PG_{y} from the picked-up image FP(t) as the effective region when calculating the horizontal axis projected feature vector H(t). The local feature value calculating unit 62 then calculates the horizontal direction local feature values for the respective pixels in the effective region AR(t)ₓ on the picked-up image FP(t) and the integral projection unit 63 calculates the horizontal axis projected feature vector H(t) by projecting the calculated local feature values onto the horizontal axis.

Also, as shown on the right in the middle of FIG. 11, the effective region calculating unit 93 sets the effective region AR(t+1)ₓ obtained by excluding a region from the lower edge of the picked-up image FP(t+1) to a position separated by the magnitude of the predicted value PG_{y} from the picked-up image FP(t+1) as the effective region when calculating the horizontal axis projected feature vector H(t+1). The local feature value calculating unit 62 then calculates the horizontal direction local feature values for the respective pixels in the effective region AR(t+1)ₓ on the picked-up image FP(t+1) and the integral projection unit 63 calculates the horizontal axis projected feature vector H(t+1) by projecting the calculated local feature values onto the horizontal axis.

The predicted value PG_{y} of the y component of the global motion vector shows the positional relationship in the y direction between the picked-up image FP(t) and the picked-up image FP(t+1). For example, when the picked-up images are placed on top of one another based on the predicted value PG_{y}, as shown at the top in FIG. 11, the picked-up image FP(t) and the picked-up image FP(t+1) will overlap one another in the y direction having been shifted by the magnitude of the predicted value PG_{y}. For this reason, by excluding a part where one picked-up image does not coincide with the other picked-up image from the extraction of local feature values, it is possible to calculate the horizontal axis projected feature vector using only the part where the two picked-up images coincide and thereby calculate the global motion vector with high precision.

In addition, in the same way as for the x component, as shown on the left at the bottom in FIG. 11, the effective region calculating unit 93 sets the effective region AR(t)_{y} obtained by excluding a region from the left edge of the picked-up image FP(t) to a position separated by the magnitude of the predicted value PGₓ from the picked-up image FP(t) as the effective region when calculating the vertical axis projected feature vector V(t). The local feature value calculating unit 62 then calculates the vertical direction local feature values for the respective pixels in the effective region AR(t)_{y} on the picked-up image FP(t) and the integral projection unit 63 calculates the vertical axis projected feature vector V(t) by projecting the calculated local feature values onto the vertical axis.

Also, as shown on the right at the bottom in FIG. 11, the effective region calculating unit 93 sets the effective region AR(t+1)_{y} obtained by excluding a region from the right edge of the picked-up image FP(t+1) to a position separated by the magnitude of the predicted value PGₓ from the picked-up image FP(t+1) as the effective region when calculating the vertical axis projected feature vector V(t+1). The local feature value calculating unit 62 then calculates the vertical direction local feature values for the respective pixels in the effective region AR(t+1)_{y} on the picked-up image FP(t+1) and the integral projection unit 63 calculates the vertical axis projected feature vector V(t+1) by projecting the calculated local feature values onto the vertical axis.

Returning to the description of the flowchart in FIG. 9, once the horizontal axis projected feature vectors and the vertical axis projected feature vectors have been obtained, the processing in step S46 and step S47 is then carried out and the global motion vector calculating process ends. Note that since such processing is the same as the processing in step S14 and step S15 in FIG. 5, description thereof is omitted.

However, in step S46, the calculated global motion vector is supplied from the global motion vector calculating unit 64 to the global motion vector holding unit 91. The global motion vector holding unit 91 temporarily stores the global motion vector and also supplies the global motion vector to component elements provided downstream.

By doing so, the image pickup apparatus 11 predicts the global motion vector of the frame to be processed from the global motion vectors of past frames, extracts the local feature values from an effective region decided using such predicted values, and then calculates the actual global motion vector.

In this way, by calculating the global motion vector using only the local feature values of pixels in the effective region, it is possible to obtain the global motion vector at higher speed and with higher precision.

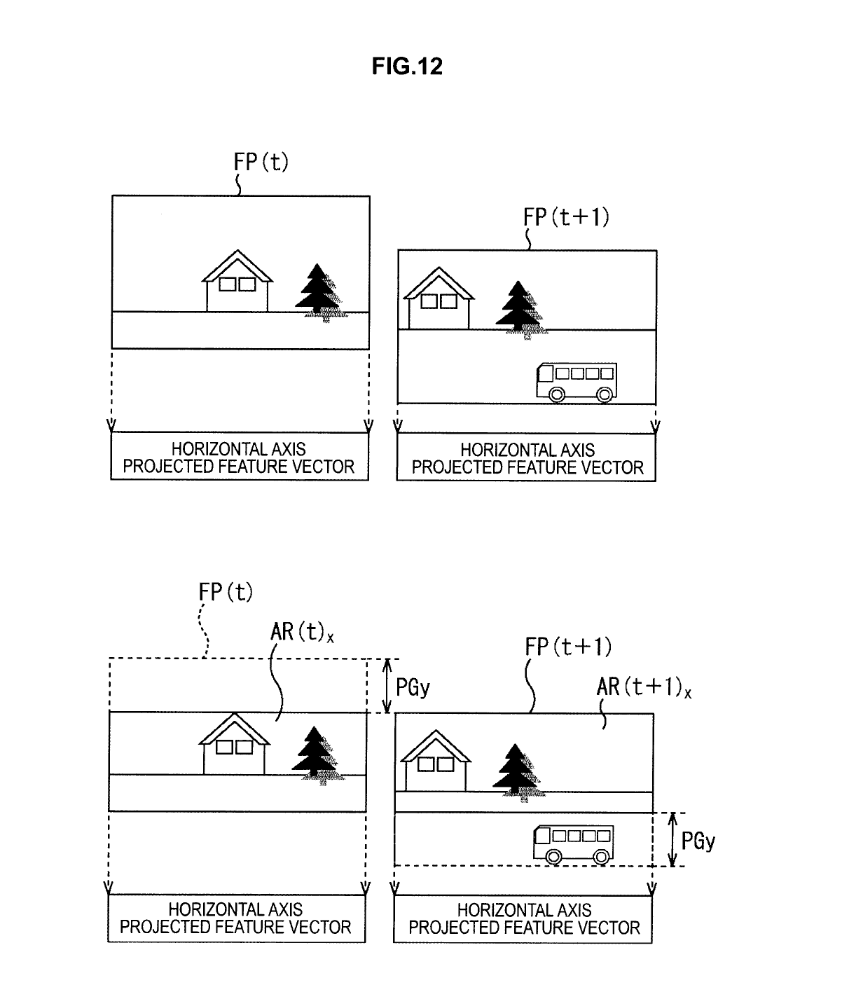

As one example, as shown in FIG. 12, assume that image pickup has been carried out consecutively for the picked-up image FP(t) of frame t and the picked-up image FP(t+1) of frame (t+1) for subjects such as a house and trees. When doing so, between image pickup of the picked-up image FP(t) and image pickup of the picked-up image FP(t+1), assume that the image pickup apparatus 11 was moved in a direction that is downward and to the right in FIG. 12. Note that in FIG. 12, the horizontal direction and the vertical direction show the x direction and the y direction.

In this case, with the first embodiment described earlier, as shown at the top of FIG. 12, the horizontal axis projected feature vector H(t) and the horizontal axis projected feature vector H(t+1) are calculated by extracting local feature values from the entire picked-up images FP(t) and FP(t+1).

This means that as one example, local feature values extracted from a region of a subject not included in the picked-up image FP(t), that is, the region with the bus for the example in FIG. 12, will contribute to the calculation of the horizontal axis projected feature vector H(t+1) for the picked-up image FP(t+1). If this happens, an error is produced in the matching of horizontal axis projected feature vectors and the calculation precision of the global motion vector will fall.

On the other hand, with the global motion vector calculating process described with reference to FIG. 9, as shown at the bottom of FIG. 12, local feature values are extracted from only the effective region obtained by excluding the region found using the predicted value PG_{y} for the y component of the global motion vector from the entire region of the picked-up image.

That is, local feature values are extracted from the effective region AR(t)ₓ obtained by excluding the upper region in the drawing of the picked-up image FP(t) to calculate the horizontal axis projected feature vector H(t). Also, local feature values are extracted from the effective region AR(t+1)ₓ obtained by excluding the lower region in the drawing of the picked-up image FP(t+1) to calculate the horizontal axis projected feature vector H(t+1).

By setting the effective region in this way to limit the region to be processed, it is possible to calculate the horizontal axis projected feature vectors by excluding a subject region (for example, the region with the bus) that is included in the picked-up image FP(t+1) but is not included in the picked-up image FP(t), for example. That is, if only a region of subjects included in both the picked-up image FP(t) and the picked-up image FP(t+1) is set so as to be processed, since subjects included in only one picked-up image will have no influence, it is possible to reduce the risk of matching errors for the horizontal axis projected feature vectors.

Note that in the same way as for the horizontal axis projected feature vectors, by also deciding an effective region for the vertical axis projected feature vectors, it is possible to reduce the risk of matching errors.

The effect of reducing matching errors in this way is greater the closer the predicted values of the global motion vector are to the real values of the global motion vector. For example, if images are picked up consecutively by continuous shooting at a typical rate while moving the image pickup apparatus 11 which is a camera or the like, in many cases there will be no big difference between the global motion vectors for consecutive frames regardless of whether the image pickup apparatus 11 is handheld or is fixed to a tripod. This means that it is comparatively easy to predict the global motion vectors and to obtain a large effect in reducing matching errors.

Also, when an effective region is set for the picked-up image, the cost of calculating the local feature values is reduced by the ratio of the area of the entire picked-up image to the area of the region of the picked-up image that excludes the effective region. In particular, if feature values with a high calculation cost are used as the local feature values, there will be a large reduction in the calculation cost of the local feature values.

### Third Embodiment

### Configuration of Image Processing Circuit

Note that although an example where the effective region is decided based on predicted values of a global motion vector has been described above, the effective region may be decided using information (hereinafter referred to as “lens distortion information”) relating to distortion of the lens 21 in addition to the predicted values.

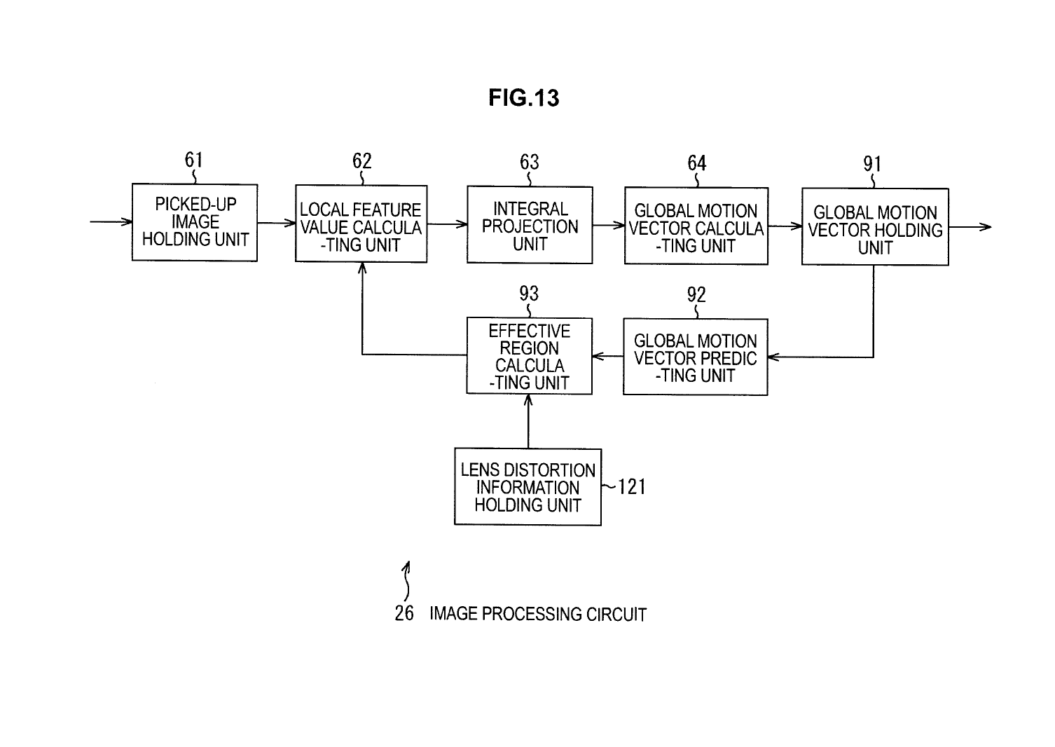

In this case, the image processing circuit 26 in FIG. 3 is configured as shown in FIG. 13. Note that parts in FIG. 13 that correspond to the case shown in FIG. 8 have been assigned the same reference numerals and description thereof is omitted as appropriate.

The image processing circuit 26 in FIG. 13 includes the picked-up image holding unit 61, the local feature value calculating unit 62, the integral projection unit 63, the global motion vector calculating unit 64, the global motion vector holding unit 91, the global motion vector predicting unit 92, the effective region calculating unit 93, and a lens distortion information holding unit 121.

The configuration of the image processing circuit 26 in FIG. 13 differs to the image processing circuit 26 in FIG. 8 by being newly equipped with the lens distortion information holding unit 121 and is otherwise the same as the image processing circuit 26 in FIG. 8.

The lens distortion information holding unit 121 holds lens distortion information relating to the lens 21 in advance and supplies the held lens distortion information to the effective region calculating unit 93. The effective region calculating unit 93 decides the effective region based on the predicted values of the global motion vector supplied from the global motion vector predicting unit 92 and the lens distortion information supplied from the lens distortion information holding unit 121 and supplies the effective region to the local feature value calculating unit 62.

### Description of Global Motion Vector Calculating Process

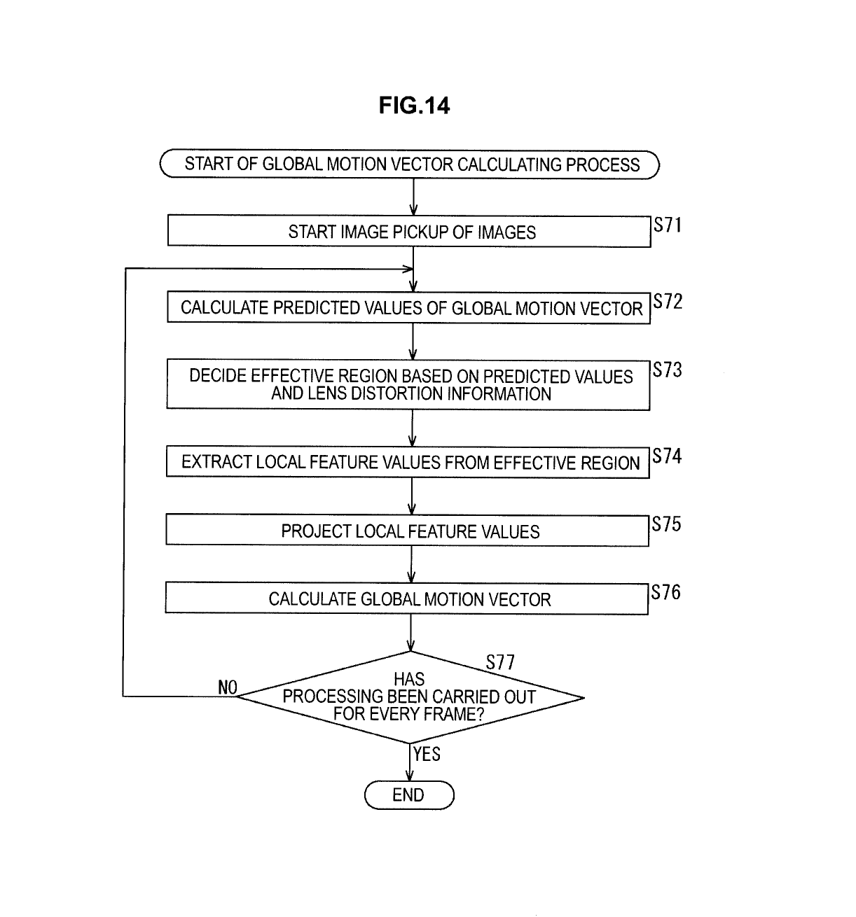

Next, the global motion vector calculating process for the case where the image processing circuit 26 of the image pickup apparatus 11 is configured as shown in FIG. 13 will be described with reference to FIG. 14. Note that since the processing in step S71 and step S72 is the same as the processing in step S41 and step S42 in FIG. 9, description thereof is omitted.

In step S73, the effective region calculating unit 93 decides the effective region based on the predicted values of the global motion vector supplied from the global motion vector predicting unit 92 and the lens distortion information supplied from the lens distortion information holding unit 121 and supplies the effective region to the local feature value calculating unit 62.

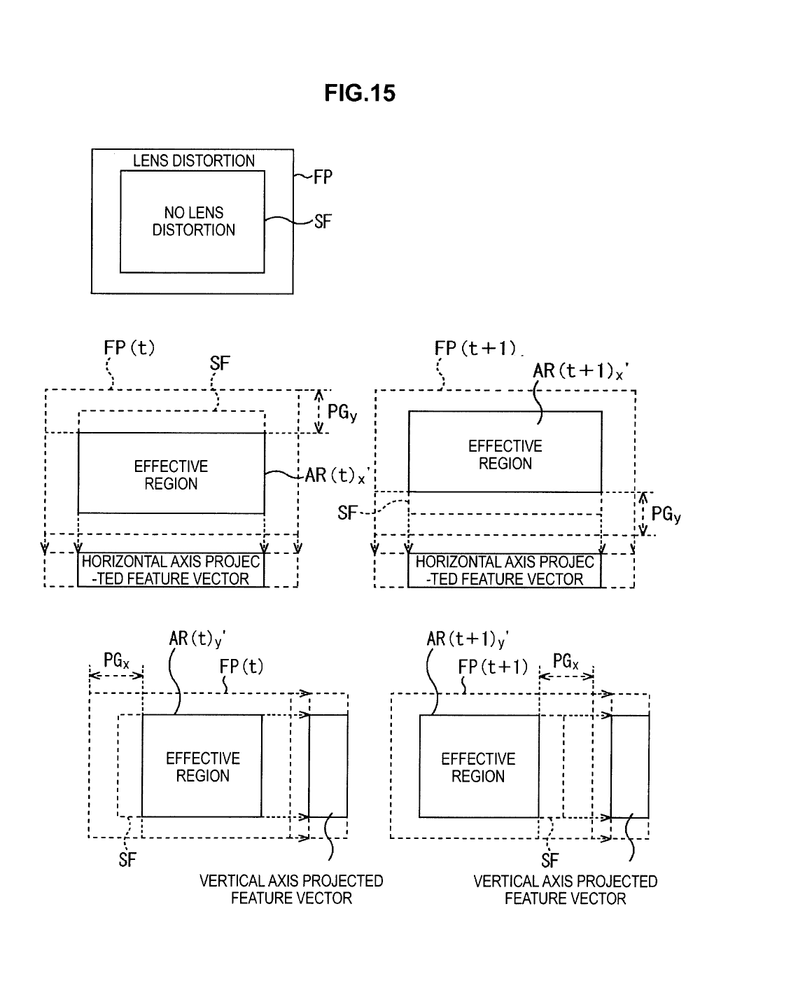

For example, as shown at the top in FIG. 15, in the undistorted region SF in the center of the picked-up image FP, it is assumed that image distortion does not occur due to the influence of the lens 21 during image pickup, while for the region near the edges of the picked-up image FP, that is, the region aside from the undistorted region SF, image distortion occurs. That is, a region where the image distortion due to the influence of the optical system such as the lens 21 is within a certain tolerated range is set as the undistorted region SF.

Information specifying the undistorted region SF is the lens distortion information, and the x component and the y component of the predicted values of the global motion vector are respectively expressed as PGₓ and PG_{y}.

In this case, as shown in the middle of FIG. 15, the effective region calculating unit 93 sets the region AR(t)ₓ′ on the picked-up image FP(t) and the region AR(t+1)ₓ′ on the picked-up image FP(t+1) as the effective regions when calculating the horizontal axis projected feature vectors.

Here, the region AR(t)ₓ′ (hereinafter referred to as the “effective region AR(t)ₓ′”) is a region included in the undistorted region SF out of the region obtained by excluding a region from the upper edge of the picked-up image FP(t) to a position separated by the magnitude of the predicted value PG_{y} from the picked-up image FP(t). That is, the effective region AR(t)ₓ′ is a region included in the undistorted region SF out of the region inside the effective region AR(t)ₓ′ in FIG. 11 described earlier.

In the same way, the region AR(t+1)ₓ′ (hereinafter referred to as the “effective region AR(t+1)ₓ′”) is a region included in the undistorted region SF out of the region obtained by excluding the region from the lower edge of the picked-up image FP(t+1) to the position separated by the magnitude of the predicted value PG_{y} from the picked-up image FP(t+1).

When the lens 21 causes distortion of subjects in the picked-up image, different errors will occur for the movement vectors of the subjects in each region depending on the extent of the distortion, which makes it difficult to calculate a single global motion vector. For this reason, by further limiting the effective region based on the lens distortion information so as to set only a region where the effects of image distortion due to the lens 21 is small (normally near the center of the image) as the region where local feature values are to be extracted, it is possible to obtain a global motion vector with higher precision and with higher speed.

That is, since the effective region decided by the predictive values of the global motion vector is further limited to only a useful region, a reduction in the calculation cost of the local feature values and the like and also an improvement in the matching process precision can be expected.

In the same way as for the x components, as shown at the bottom of FIG. 15, the effective region calculating unit 93 sets the region AR(t)_{y}′ on the picked-up image FP(t) and the region AR(t+1)_{y}′ on the picked-up image FP(t+1) as the effective regions when calculating the vertical axis projected feature vectors.

Here, the region AR(t)y′ (hereinafter referred to as the “effective region AR(t)_{y}′”) is a region included in the undistorted region SF out of the region obtained by excluding a region from the left edge of the picked-up image FP(t) to a position separated by the magnitude of the predicted value PGₓ from the picked-up image FP(t). That is, the effective region AR(t)_{y}′ is a region included in the undistorted region SF out of the region inside the effective region AR(t)_{y}′ in FIG. 11 described earlier.

In the same way, the region AR(t+1)_{y}′ (hereinafter referred to as the “effective region AR(t+1)_{y}′”) is a region included in the undistorted region SF out of the region obtained by excluding a region from the right edge of the picked-up image FP(t+1) to a position separated by the magnitude of the predicted value PGₓ from the picked-up image FP(t+1).

Returning to the description of the flowchart in FIG. 14, once the effective region has been set, after this the processing in step S74 to step S77 is carried out and the global motion vector calculating process ends. Note that since such processing is the same as in step S44 to step S47 in FIG. 9, description thereof is omitted here.

However, in step S74, the local feature values are extracted respectively from the effective region AR(t)ₓ′, the effective region AR(t)_{y}′, the effective region AR(t+1)ₓ′, and the effective region AR(t+1)_{y}′ in FIG. 15.

As described above, the image pickup apparatus 11 decides the effective region from the predicted values of the global motion vector and the lens distortion information and calculates the actual global motion vector by extracting the local feature values from the decided effective region. In this way, by limiting the region used to extract the local feature values according to the lens distortion information, it is possible to obtain the global motion vector at higher speed and with higher precision.

Note that although a case where the effective region is decided from the predicted values of the global motion vector and the lens distortion information has been described, it is also possible to set the undistorted region SF shown by the lens distortion information as the effective region.

### Fourth Embodiment

### Configuration of Image Processing Circuit

Although a case where the region used to extract the local feature values is limited according to the lens distortion information has been described above, it is also possible to exclude the region of specified subjects, such as moving subjects, (hereinafter referred to as “excluded subjects”) from the region used to extract the local feature values.

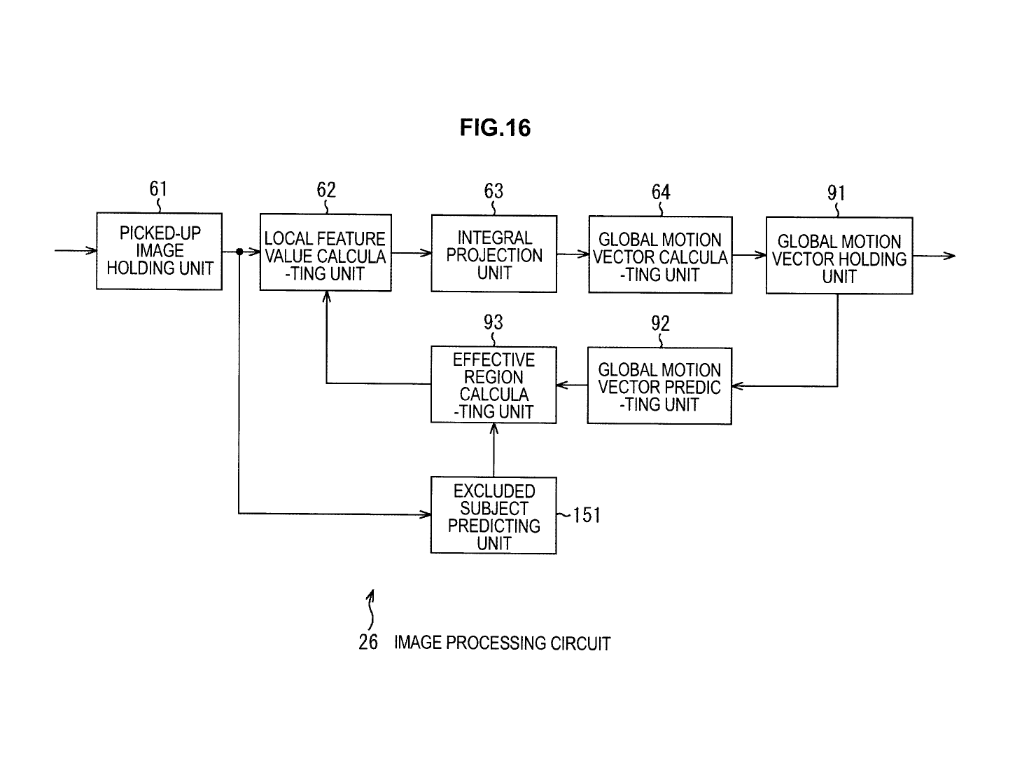

In this case, the image processing circuit 26 in FIG. 3 is configured as shown in FIG. 16. Note that in FIG. 16, parts that correspond to the case shown in FIG. 13 have been assigned the same reference numerals and description thereof is omitted as appropriate.

The image processing circuit 26 in FIG. 16 includes the picked-up image holding unit 61, the local feature value calculating unit 62, the integral projection unit 63, the global motion vector calculating unit 64, the global motion vector holding unit 91, the global motion vector predicting unit 92, the effective region calculating unit 93, and an excluded subject predicting unit 151.

The configuration of the image processing circuit 26 in FIG. 16 differs to the image processing circuit 26 in FIG. 13 by including the excluded subject predicting unit 151 in place of the lens distortion information holding unit 121 in FIG. 13 and is otherwise the same as the image processing circuit 26 in FIG. 13.

In the image processing circuit 26 in FIG. 16, the picked-up images held in the picked-up image holding unit 61 are supplied not only to the local feature value calculating unit 62 but also to the excluded subject predicting unit 151. The excluded subject predicting unit 151 estimates the region of excluded subjects from the picked-up images supplied from the picked-up image holding unit 61 and supplies the estimation result to the effective region calculating unit 93.

The effective region calculating unit 93 decides the effective region based on the predicted values of the global motion vector supplied from the global motion vector predicting unit 92 and the estimation result for the region of the excluded subjects supplied from the excluded subject predicting unit 151, and supplies the effective region to the local feature value calculating unit 62.

### Description of the Global Motion Vector Calculating Process

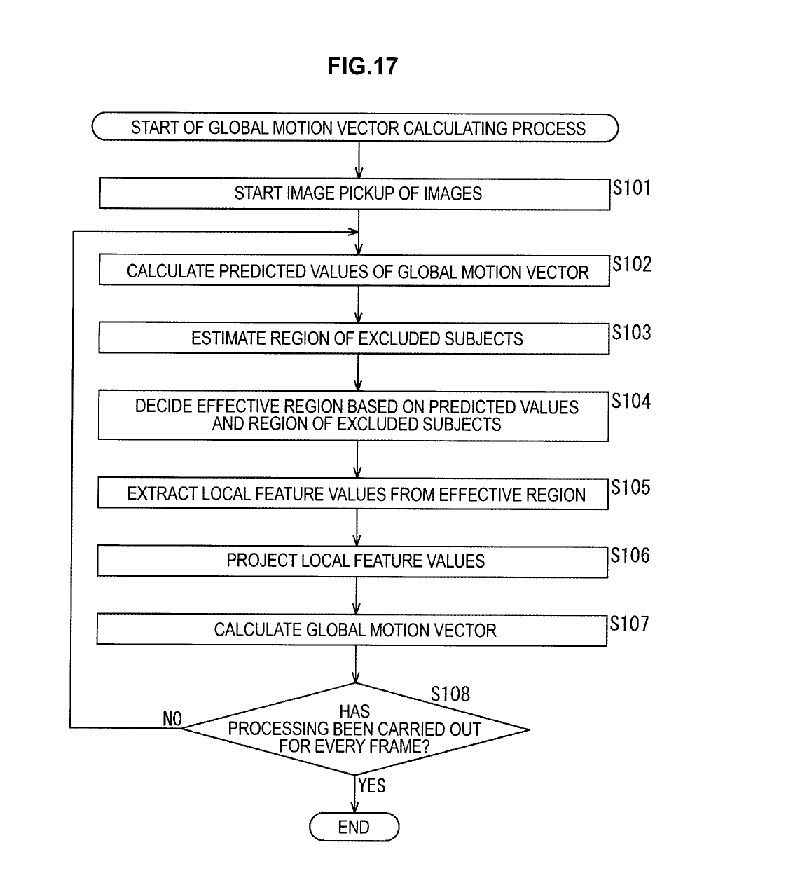

Next, the global motion vector calculating process for the case where the image processing circuit 26 of the image pickup apparatus 11 is configured as shown in FIG. 16 will be described with reference to the flowchart in FIG. 17. Note that since the processing in step S101 and step S102 is the same as the processing in step S71 and step S72 in FIG. 14, description thereof is omitted.

In step S103, the excluded subject predicting unit 151 estimates the region of the excluded subjects from the picked-up images supplied from the picked-up image holding unit 61 and supplies the estimation result to the effective region calculating unit 93.

For example, the excluded subject predicting unit 151 sets the region of moving subjects, such as the region of a person or face detected through person detection or face detection and the region of a car or the like detected by object detection, as the region of the excluded subjects. Also, a region of a subject included in only one of the picked-up image FP(t) and the picked-up image FP(t+1) may be detected and set as the region of the excluded subjects.

In addition, the excluded subject predicting unit 151 sets a region on the picked-up images composed of both a region of the excluded subjects detected from the picked-up image FP(t) and a region of the excluded subjects detected from the picked-up image FP(t+1) as the final region of the excluded subjects.

In step S104, the effective region calculating unit 93 decides the effective region based on the predicted values of the global motion vector from the global motion vector predicting unit 92 and the region of the excluded subjects from the excluded subject predicting unit 151 and supplies the effective region to the local feature value calculating unit 62.

That is, the effective region calculating unit 93 sets a region obtained by further excluding the region of the excluded subjects from the effective region on the picked-up images decided from the predicted values of the global motion vector as the final effective region. More specifically, regions produced by excluding the region of the excluded subjects from the effective region AR(t)x, the effective region AR(t)y, the effective region AR(t+1)x, and the effective region AR(t+1)y in FIG. 11 for example, that is, regions that do not include the region of the excluded subjects are set as the effective regions.

Once the effective region has been found, the processing in step S105 to step S108 is then carried out and the global motion vector calculating process ends. Since such processing is the same as the processing in step S74 to step S77 in FIG. 14, description thereof is omitted.

As described above, the image pickup apparatus 11 decides the effective region from the predicted values of the global motion vectors and the region of the excluded subjects and extracts the local feature values from the decided effective region to calculate the actual global motion vector.

In this way, by limiting the region for extracting the local feature values according to the region of the excluded subjects, it is possible to obtain the global motion vector at high speed and with higher precision. In particular, by setting a region with a subject where there is the risk of a drop in calculation precision for the global motion vector, that is, a region with a moving subject, as the region of the excluded subjects that is to be excluded from the extraction of local feature values, it is possible to improve the robustness of the global motion vector.

Note that although a case where the effective region is decided from the predicted values of the global motion vector and the region of the excluded subjects has been described, it is also possible to set the entire region aside from the region of the excluded subjects on the picked-up images as the effective region. It is also possible to decide the effective region based on the predicted values of the global motion vector, the region of the excluded subjects, and the lens distortion information.

### Fifth Embodiment

### Configuration of Image Processing Circuit

In addition, although examples where the local feature values are extracted from the picked-up images themselves have been described above, it is also possible to reduce the picked-up images and then extract the local feature values from the reduced picked-up images (hereinafter simply “reduced images”).

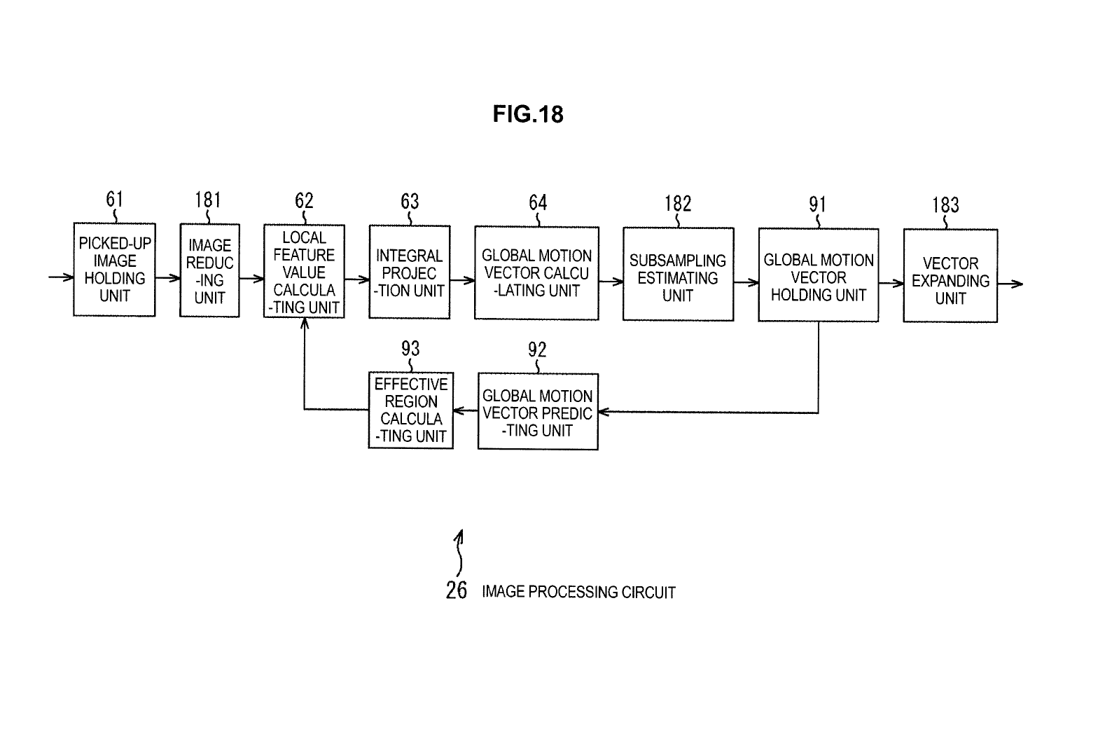

In this case, the image processing circuit 26 in FIG. 3 is configured as shown in FIG. 18. Note that in FIG. 18, parts that are the same as in FIG. 8 have been assigned the same reference numerals and description thereof is omitted as appropriate.

The image processing circuit 26 in FIG. 18 includes the picked-up image holding unit 61, an image reducing unit 181, the local feature value calculating unit 62, the integral projection unit 63, the global motion vector calculating unit 64, a subsampling estimating unit 182, the global motion vector holding unit 91, a vector expanding unit 183, the global motion vector predicting unit 92, and the effective region calculating unit 93.

The configuration of the image processing circuit 26 in FIG. 18 differs to the image processing circuit 26 in FIG. 8 by newly including the image reducing unit 181, the subsampling estimating unit 182, and the vector expanding unit 183 and is otherwise the same as the image processing circuit 26 in FIG. 8.

The image reducing unit 181 generates reduced images by reducing picked-up images supplied from the picked-up image holding unit 61 and supplies the reduced images to the local feature value calculating unit 62. The local feature value calculating unit 62 extracts the local feature values from the effective region supplied from the effective region calculating unit 93 out of the region of the reduced images supplied from the image reducing unit 181 and supplies the local feature values to the integral projection unit 63.

The subsampling estimating unit 182 calculates a global motion vector at a subsampling level of precision based on the global motion vector supplied from the global motion vector calculating unit 64 and the horizontal axis projected feature vectors and the vertical axis projected feature vectors, and supplies such global motion vector to the global motion vector holding unit 91. The vector expanding unit 183 expands and outputs a global motion vector supplied from the global motion vector holding unit 91.

### Description of Global Motion Vector Calculating Process

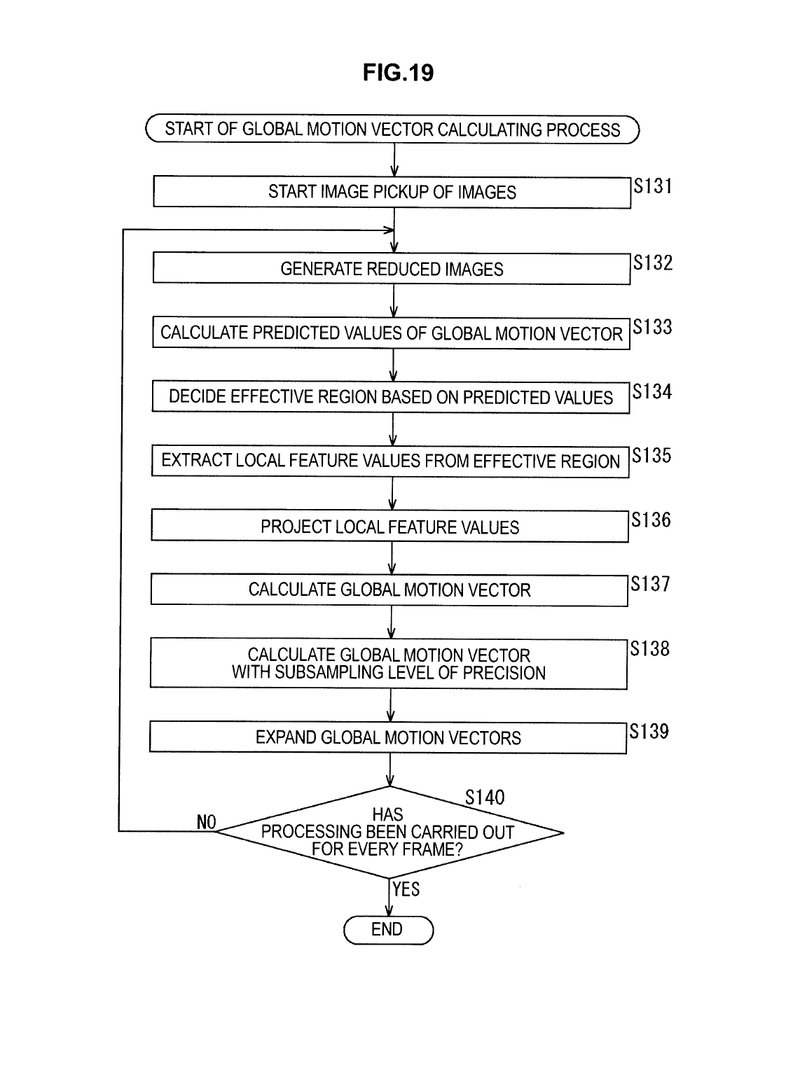

Next, the global motion vector calculating process for a case where the image processing circuit 26 of the image pickup apparatus 11 is configured as shown in FIG. 18 will be described with reference to the flowchart in FIG. 19. Note that since the processing in step S131 is the same as the processing in step S41 in FIG. 9, description thereof is omitted.

In step S132, the image reducing unit 181 acquires the picked-up image FP(t+1) of the frame (t+1) to be processed and the picked-up image FP(t) of frame t from the picked-up image holding unit 61 and reduces such picked-up images to generate reduced images. The image reducing unit 181 supplies the reduced images produced by reducing the picked-up images to the local feature value calculating unit 62.

Once the reduced images have been generated, the processing in step S133 to step S137 is then carried out to generate a global motion vector, but since such processing is the same as the processing in step S42 to step S46 in FIG. 9, description thereof is omitted.

However, in the processing in step S133 to step S137, the effective region is decided for the reduced images, the local feature values are extracted from the effective region of the reduced images to generate the horizontal axis projected feature vectors and the vertical axis projected feature vectors, and the global motion vector is calculated. Accordingly, the obtained global motion vector is a global motion vector for a reduced image.

Once the global motion vector calculating unit 64 has calculated the global motion vector for the reduced image, the calculated global motion vector and the horizontal axis projected feature vectors and vertical axis projected feature vectors are supplied to the subsampling estimating unit 182.

In step S138, the subsampling estimating unit 182 calculates the global motion vector at the subsampling level of precision based on the global motion vector, the horizontal axis projected feature vectors, and the vertical axis projected feature vectors supplied from the global motion vector calculating unit 64. For example, by carrying out isometric linear fitting, parabolic fitting, or the like, the subsampling estimating unit 182 calculates the global motion vector with a subsampling level of precision, that is, a level of precision equal to or smaller than pixels of the reduced images.

Although the global motion vector calculating process carried out by the image processing circuit 26 has an ultimate aim of obtaining a global motion vector for a picked-up image, the processes in step S133 to step S137 are carried out using reduced images. This means that the obtained global motion vector is a global motion vector for the reduced images where the global motion vector of the picked-up images to be ultimately obtained is reduced, and the precision of the global motion vector is also at the subsampling (pixel) level of the reduced images.

For this reason, the subsampling estimating unit 182 calculates the global motion vector at a subsampling level of precision that is equal to or smaller than the sampling of the reduced images, and supplies the global motion vector to the global motion vector holding unit 91. The global motion vector holding unit 91 holds the global motion vector supplied from the subsampling estimating unit 182 and supplies the global motion vector to the vector expanding unit 183.

The global motion vector holding unit 91 also supplies the held global motion vector to the global motion vector predicting unit 92 as a global motion vector of the reduced image of a past frame. Accordingly, in the global motion vector predicting unit 92, predicted values of a global motion vector of a reduced image are calculated.

In step S139, the vector expanding unit 183 expands the global motion vector supplied from the global motion vector holding unit 91 using the reciprocal of the reduction ratio used when generating the reduced images and thereby generates the global motion vector of a picked-up image. That is, by expanding the global motion vector of a reduced image, the global motion vector of a picked-up image is obtained.

Once the vector expanding unit 183 has outputted the obtained global motion vector of the picked-up image, the processing in step S140 is carried out and the global motion vector calculating process ends. Since such processing is the same as the processing in step S47 in FIG. 9, description thereof is omitted.

As described above, by generating the reduced images, extracting the local feature values from an effective region on the reduced images to calculate a global motion vector for a reduced image, and then expanding the obtained global motion vector, the image pickup apparatus 11 obtains the global motion vector of a picked-up image.

In this way, by calculating a global motion vector for a reduced image and expanding the obtained global motion vector to produce the global motion vector of a picked-up image, it is possible to obtain the global motion vector at higher speed and higher precision.

In particular, by calculating the global motion vectors using reduced images, it is possible to reduce the area of the region used to extract the local feature values and to reduce the calculation cost of the matching process. Although the use of reduced images involves reduction of the picked-up images and expansion of a global motion vector, the calculation cost of calculating the global motion vectors can be reduced as a whole, which means that it is possible to obtain the global motion vectors at higher speed.

Also, since high-frequency components in the picked-up images are removed by reducing the picked-up images, a noise-reducing effect can be expected, which can increase the robustness of the generated global motion vectors.

### Sixth Embodiment

### Configuration of Image Processing Circuit

Note that although examples where global motion vectors are calculated in the image processing circuit 26 have been described above, it is also possible to use the calculated global motion vectors to generate a panorama image.

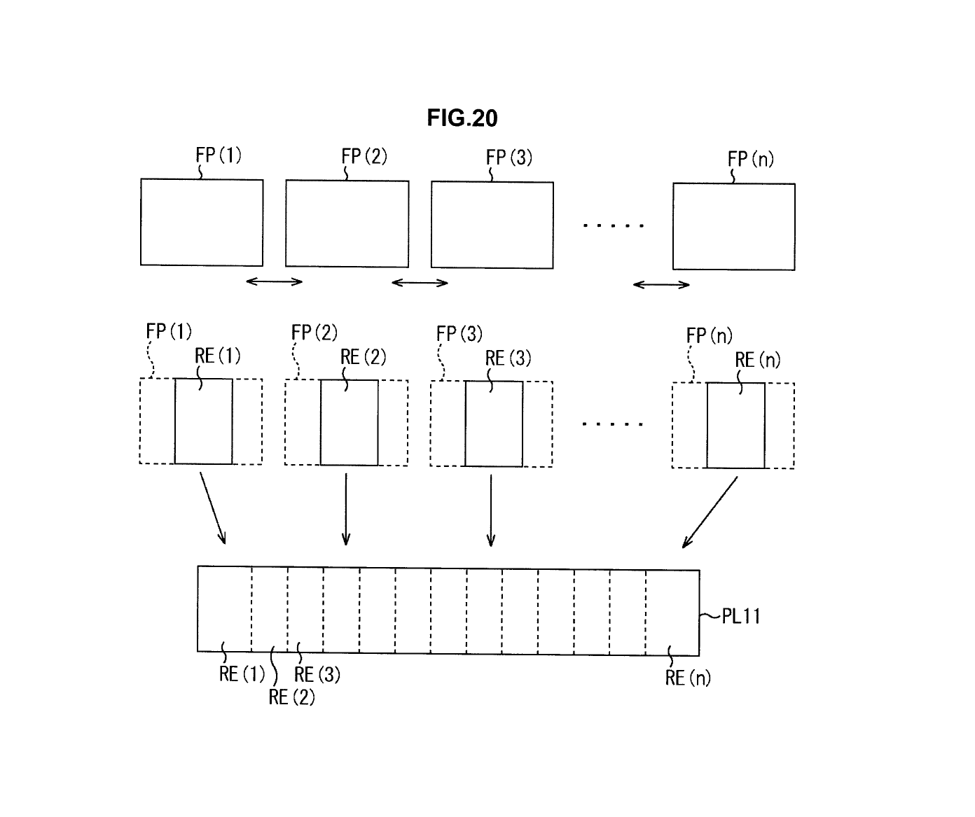

In such case, as shown in FIG. 20 for example, based on the global motion vectors, strip-like regions RE (1) to RE(n) used to generate a panorama image are decided for n picked-up images numbered picked-up image FP(1) to picked-up image FP(n). After this, a single panorama image PL11 is generated by aligning and combining the strip-like regions RE (1) to RE(n). Note that in FIG. 20, the horizontal direction and the vertical direction respectively show the x direction and the y direction.

As one example, when an axis (hereinafter referred to as the “sweep axis”) parallel to the direction in which the image pickup apparatus 11 was moved in parallel during image pickup is parallel to the horizontal axis (that is, the x axis) in FIG. 20, the positions of the strip-like regions are decided based on the x components of the global motion vectors of the respective picked-up images.

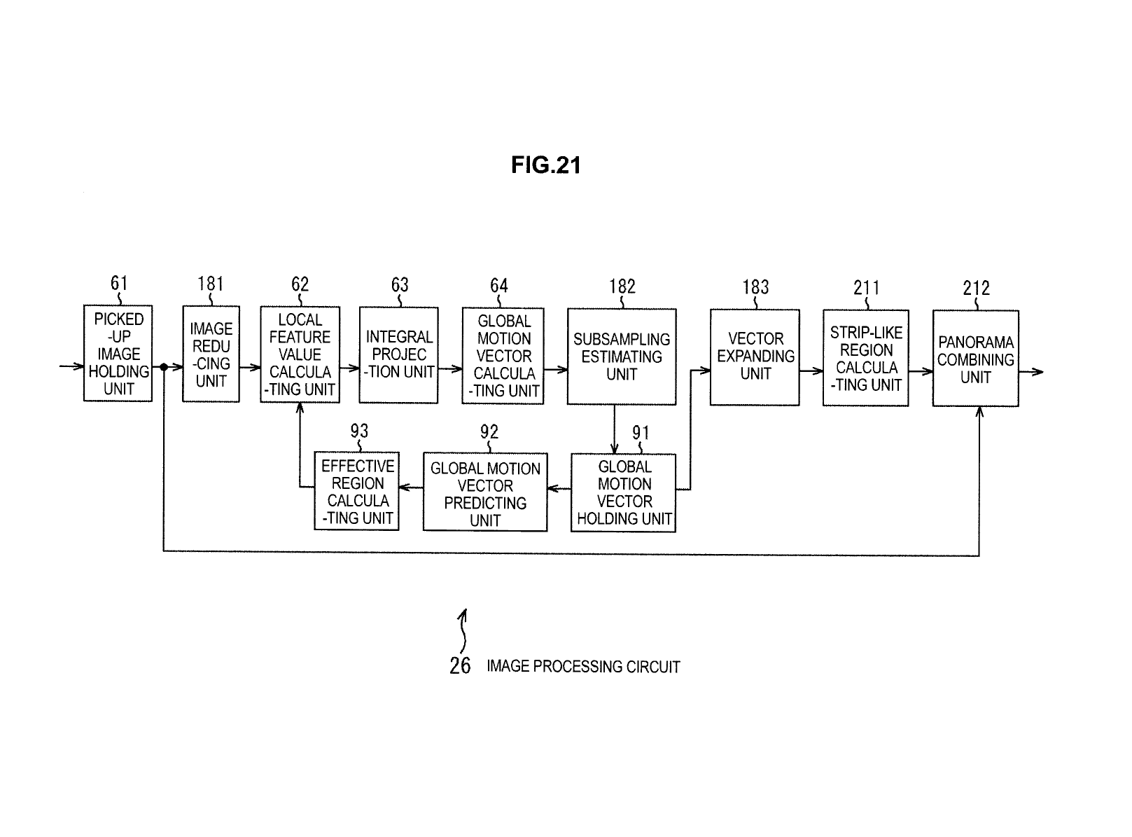

Also, when a panorama image is generated, the image processing circuit 26 in FIG. 3 is configured as shown in FIG. 21. Note that parts in FIG. 21 that are the same as the case shown in FIG. 18 have been assigned the same reference numerals and description thereof is omitted as appropriate.

The image processing circuit 26 in FIG. 21 includes the picked-up image holding unit 61, the image reducing unit 181, the local feature value calculating unit 62, the integral projection unit 63, the global motion vector calculating unit 64, the subsampling estimating unit 182, the global motion vector holding unit 91, the vector expanding unit 183, the global motion vector predicting unit 92, the effective region calculating unit 93, a strip-like region calculating unit 211, and a panorama combining unit 212.

The configuration of the image processing circuit 26 in FIG. 21 differs to the image processing circuit 26 in FIG. 18 by newly including the strip-like region calculating unit 211 and the panorama combining unit 212 and is otherwise the same as the image processing circuit 26 in FIG. 18.

Note that in the image processing circuit 26 in FIG. 21, the picked-up images held in the picked-up image holding unit 61 are supplied to the image reducing unit 181 and the panorama combining unit 212.

The strip-like region calculating unit 211 decides the strip-like regions on the picked-up images based on the global motion vectors of the respective picked-up images supplied from the vector expanding unit 183 and supplies information showing the positions (hereinafter referred to as “connecting positions”) of the edges of the strip-like regions to the panorama combining unit 212.

The panorama combining unit 212 generates and outputs a panorama image based on information showing the connecting positions of the respective strip-like regions supplied from the strip-like region calculating unit 211 and the picked-up images supplied from the picked-up image holding unit 61.

### Description of Global Motion Vector Calculating Process

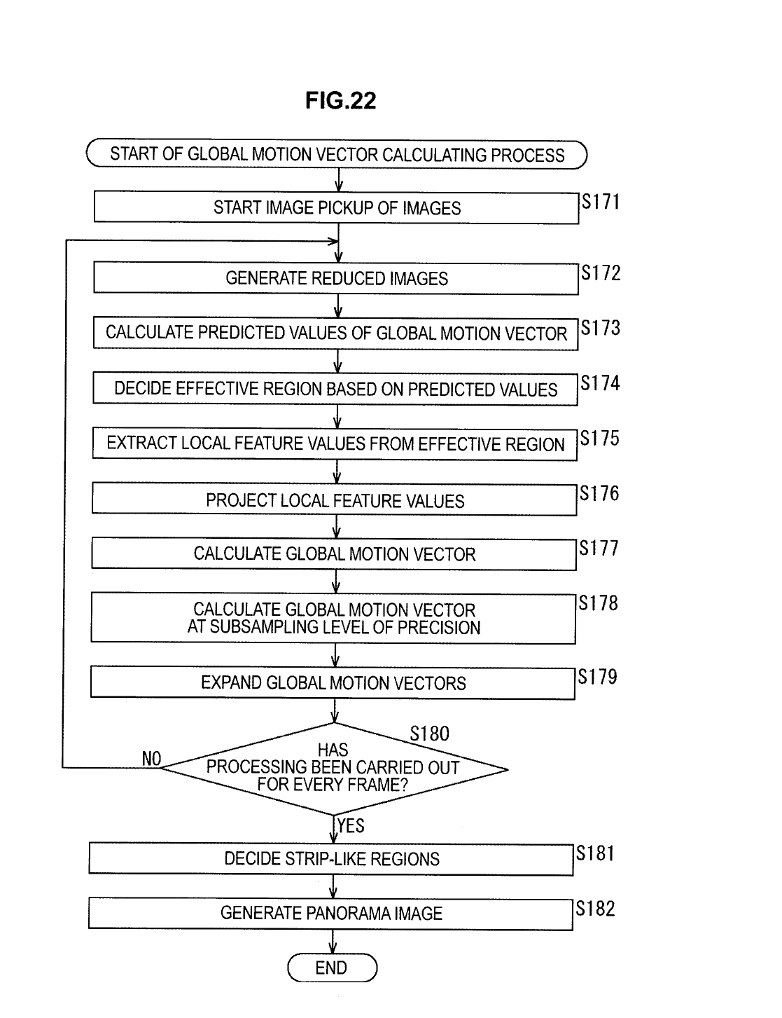

Next, the global motion vector calculating process for the case where the image processing circuit 26 of the image pickup apparatus 11 is configured as shown in FIG. 21 will be described with reference to the flowchart in FIG. 22. Note that since the processing in step S171 to step S180 is the same as the processing in step S131 to step S140 in FIG. 19, description thereof is omitted. Also, in step S180, if it is determined that processing has been carried out for every frame, the processing proceeds to step S181.

In step S181, the strip-like region calculating unit 211 decides the strip-like regions on the picked-up images based on the global motion vectors of the respective picked-up images supplied from the vector expanding unit 183 and supplies information showing the connecting positions of the respective strip-like regions to the panorama combining unit 212.

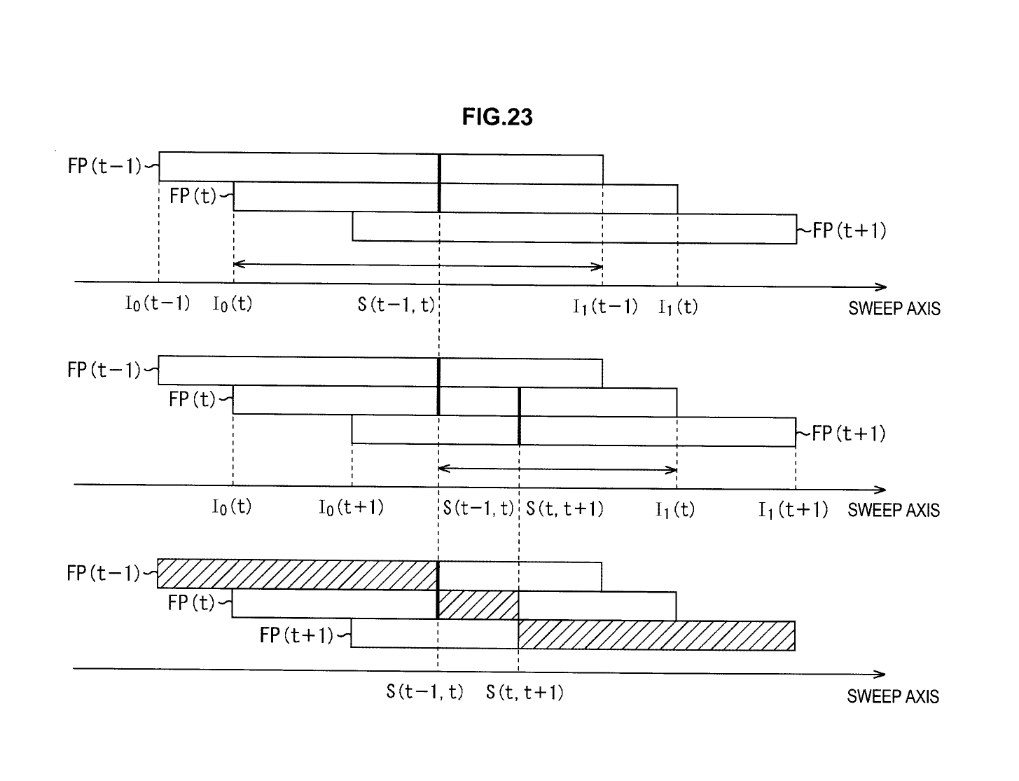

For example, as shown in FIG. 23, the strip-like region calculating unit 211 successively decides the connecting positions for the strip-like regions of the picked-up images, that is, the connecting positions for the picked-up images, in order starting with the oldest pickup time (i.e., in ascending order of frame number). Note that in FIG. 23, the horizontal direction shows the direction of the sweep axis.

In FIG. 23, the picked-up images FP(t−1) to FP(t+1) for the three consecutive frames frame (t−1) to frame (t+1) are aligned in the direction of the sweep axis based on the global motion vectors. Since the picked-up image FP (t−1) has the lowest frame number out of the picked-up images FP(t−1) to FP(t+1), the strip-like region calculating unit 211 first decides the connecting position for the picked-up image FP(t−1) and the picked-up image FP(t).

That is, as shown at the top of FIG. 23, the strip-like region calculating unit 211 decides the connecting position with a region from a position I₀(t) to a position I₁(t−1) on the sweep axis where the adjacent picked-up image FP(t−1) and picked-up image FP(t) overlap one another as the search region. Here, the position I₀(t) and the position I₁(t−1) are respectively the position of the left edge in the drawing of the picked-up image FP(t) and the position of the right edge in the drawing of the picked-up image FP(t−1).

As one example, the strip-like region calculating unit 211 sets a position S (t−1,t) midway between the position I₀(t−1) of the left edge in the drawing of the picked-up image FP(t−1) and the position I₁(t) of the right edge in the drawing of the picked-up image FP(t) as the connecting position of the picked-up image FP(t−1) and the picked-up image FP(t). That is, the position S(t−1,t) is the position of the right edge in the drawing of the strip-like region of the picked-up image FP(t−1) and the position of the left edge in the drawing of the strip-like region of the picked-up image FP(t). Note that hereinafter, the position S(t−1,t) is also referred to as the “connecting position S(t−1,t)”.

Next, the strip-like region calculating unit 211 decides the connecting position S(t,t+1) of the picked-up image FP(t) and the picked-up image FP(t+1) in the middle of FIG. 23.

Here, a position I₀(t+1) of the left edge in the drawing of the region where the picked-up image FP(t) and the picked-up image FP(t+1) overlap one another, that is, the left edge of the picked-up image FP(t+1), is positioned to the left in the drawing of the connecting position S(t−1,t) of the picked-up image FP(t−1) and the picked-up image FP(t). Since the connecting position of the picked-up image FP(t) and the picked-up image FP(t+1) should be positioned to the right in the drawing of the connecting position of the picked-up image FP(t−1) and the picked-up image FP(t), the region to the left of the connecting position S(t−1,t) should be excluded from the search region of the connecting position S(t,t+1).

For this reason, the strip-like region calculating unit 211 decides the connecting position S(t,t+1) with a region on the sweep axis from the connecting position S(t−1,t) to the position I₁(t) of the right edge in the drawing of the picked-up image FP(t) as the search region. For example, the strip-like region calculating unit 211 sets a position midway between the position I₀(t) of the left edge in the drawing of the picked-up image FP(t) and the position I₁(t+1) of the right edge in the drawing of the picked-up image FP(t+1) as the connecting position S(t,t+1).

Once the connecting positions for connecting the picked-up images of the consecutive frames have been decided in this way, as shown at the bottom in FIG. 23, in the panorama combining unit 212 located downstream, the decided strip-like regions on the picked-up images are connected to one another at the connecting positions to produce a panorama image. Note that at the bottom of FIG. 23, the obliquely shaded parts of the picked-up image FP(t−1) to the picked-up image FP(t+1) show the strip-like regions.

For example, the strip-like region of the picked-up image FP(t) is a region where the position in the sweep axis direction of the picked-up image FP(t) is from the connecting position S(t−1,t) to the connecting position S(t,t+1). In this way, by successively deciding the connecting position for another picked-up image that is adjacent to the picked-up image being processed, it is possible to successively decide the strip-like regions of the picked-up images.

Note that although a method of deciding the connecting positions for picked-up images in order of a time series has been described here, it is also possible to successively decide the connecting positions for picked-up images in an order decided according to another standard.

Returning to the description of the flowchart in FIG. 22, once the strip-like regions of the respective picked-up images have been decided, the processing proceeds from step S181 to step S182.

In step S182, the panorama combining unit 212 generates and outputs a panorama image based on information showing the connecting positions of the respective strip-like regions supplied from the strip-like region calculating unit 211 and the picked-up images supplied from the picked-up image holding unit 61. For example, the strip-like regions on the respective picked-up images are combined to produce one panorama image. Putting this another way, the respective picked-up images are connected to one another at the connecting positions to produce the panorama image.

In more detail, when combining the strip-like regions of the picked-up images, the panorama combining unit 212 weights and adds parts near the edges of the strip-like regions of the two adjacent picked-up images to generate a panorama image.

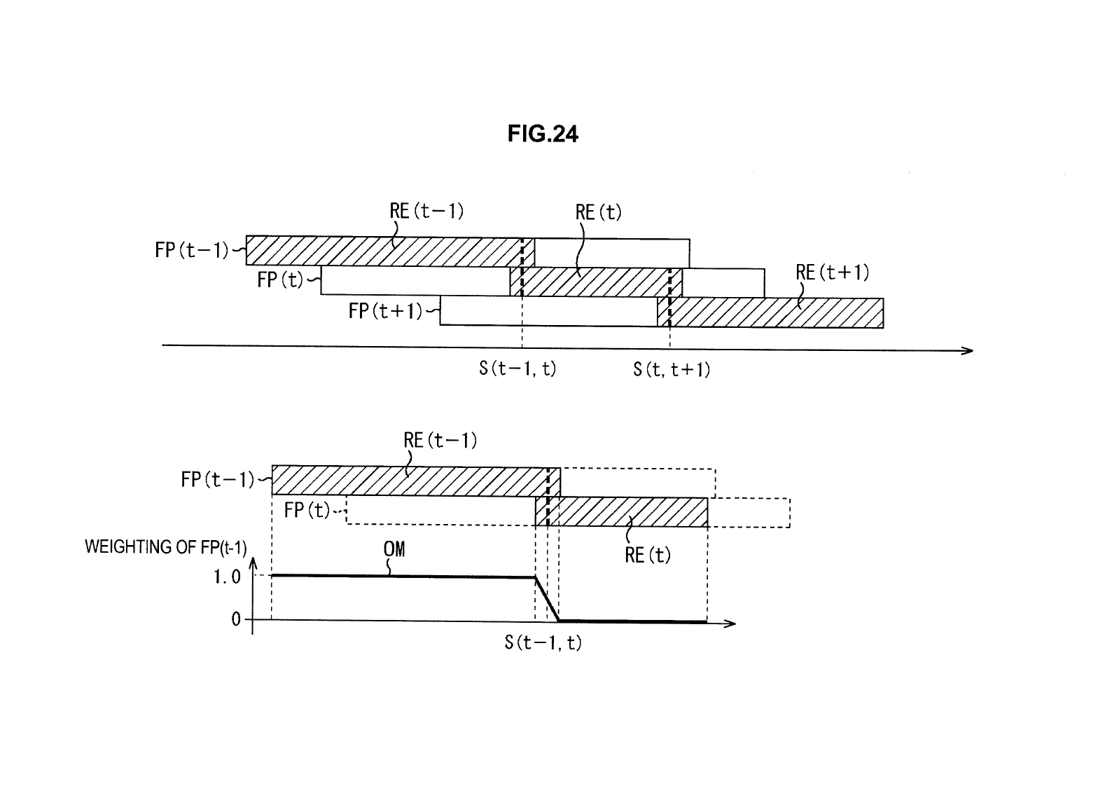

For example, as shown in FIG. 24, the strip-like regions of the picked-up images of consecutive frames are decided so as to have edge parts that overlap one another. Note that, in FIG. 24, the horizontal direction shows the sweep axis direction, and in FIG. 24 picked-up image FP(t−1) to picked-up image FP(t+1) of three consecutive frames are aligned in the x direction (the sweep axis direction).

At the top of FIG. 24, the right edge in the drawing of the strip-like region RE(t−1) of the picked-up image FP(t−1) is positioned slightly to the right of the connecting position S(t−1,t) for connecting to the picked-up image FP(t). Similarly, the left edge in the drawing of the strip-like region RE(t) of the picked-up image FP(t) is positioned slightly to the left of the connecting position S(t−1,t) for connecting to the picked-up image FP(t−1) so that regions in the peripheries of the edges of the strip-like region RE(t−1) and the strip-like region RE(t) overlap one another.

Next, when connecting the strip-like region RE(t−1) and the strip-like region RE(t), in a range in the sweep axis direction from the position of the left edge of the strip-like region RE(t) to the position of the right edge of the strip-like region RE(t−1), pixel values of pixels at the same position in the strip-like region RE(t−1) and the strip-like region RE(t) are weighted and added together.

In the same way, the strip-like region RE(t) and the strip-like region RE(t+1) overlap one another in the periphery of the connecting position S(t,t+1), and when the strip-like region RE(t) and the strip-like region RE(t+1) are connected, pixel values are weighted and added together at such overlapping parts.

When weighting and adding together the strip-like regions, as shown at the bottom of FIG. 24, the weighting used in the addition changes according to the position in the sweep axis direction. At the bottom of FIG. 24, the broken line OM shows the magnitude of the weighting used to multiply the pixels of the picked-up image FP(t−1) (the strip-like region RE(t−1)).

That is, the magnitude of the weighting from the left edge in the drawing of the strip-like region RE(t−1) to the position of the left edge of the strip-like region RE(t) is set at “1”. This is because in a region from the left edge of the strip-like region RE(t−1) to the position of the left edge of the strip-like region RE(t), the strip-like region RE(t−1) is set without amendment as the panorama image.

The magnitude of the weighting of the strip-like region RE(t−1) from the left edge in the drawing of the strip-like region RE(t) to the position of the right edge of the strip-like region RE(t−1) is set so as to become smaller toward the right in the drawing, and the magnitude of the weighting at the position of the right end of the strip-like region RE(t−1) is set at “0”.

In the part where the strip-like region RE(t−1) and the strip-like region RE(t) overlap, the contribution ratio of the strip-like region RE(t−1) for generating the panorama image increases from the connecting position S(t−1,t) toward the left edge of the strip-like region RE(t). On the other hand, the contribution ratio of the strip-like region RE(t) for generating the panorama image increases from the connecting position S(t−1,t) toward the right edge of the strip-like region RE(t−1).

In addition, since the picked-up image FP(t−1) is not used to generate the panorama image at a position to the right in the drawing of the right edge of the strip-like region RE(t−1) of the picked-up image FP(t−1), the magnitude of the weighting is set at “0”.

In this way, since the panorama image is generated using the two adjacent strip-like regions at the edge peripheries of the strip-like region and one strip-like region is used without amendment as the panorama image at other parts, it is possible to suppress blurring of the panorama image due to the picked-up images being placed on top of one another.

Also, by changing the combining ratio for the edge parts of the strip-like regions according to position, or in other words, by using a weighting gradient when weighting and adding values, it is possible to obtain a higher quality panorama image. That is, at a part where the two strip-like regions to be connected overlap one another, even if the position of the subject has shifted or the colors of pixels have changed, a smoothing effect is obtained by weighting and adding the pixel values. By doing so, it is possible to suppress omission of part of the subject, unevenness in the colors of the panorama image, and the like, and thereby obtain a more natural panorama image.

By doing so, the panorama combining unit 212 connects the strip-like regions of the picked-up images to generate a single panorama image. Note that by carrying out trimming, it is possible to set a region that is part of a single image composed of the connected strip-like regions as the panorama image.

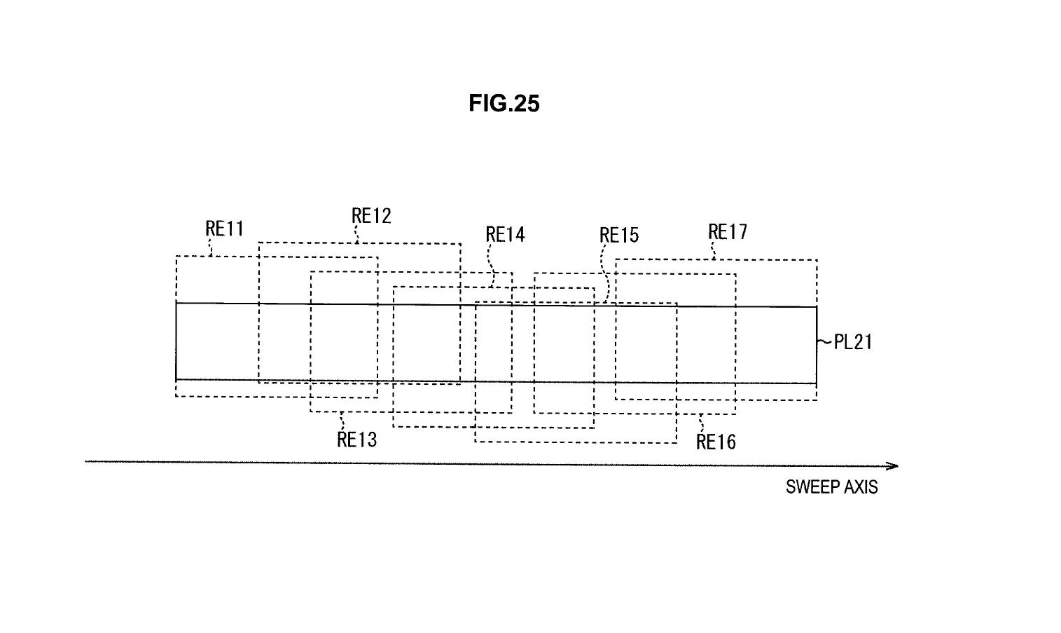

For example, if the user holds the image pickup apparatus 11 by hand and picks up images while sweeping the image pickup apparatus 11, it is difficult to keep the movement component in a different direction to the sweep axis direction at zero. For this reason, as shown in FIG. 25 for example, there are cases where the strip-like region RE11 to the strip-like region RE17 on the consecutively picked-up images have positions that vary in the up-down direction in FIG. 25.

Note that in FIG. 25, the horizontal direction in the drawing shows the sweep axis direction (x direction) and the vertical direction shows the y direction.

In the example in FIG. 25, the sweep axis is the length direction of the picked-up images, or in other words parallel to the x direction. Also, in FIG. 25, the positions in the up-down direction in the drawing of the strip-like region RE11 to the strip-like region RE17, that is, the positions in a direction perpendicular to the sweep direction differ for each picked-up image.

For this reason, the single image obtained by connecting the strip-like regions of the respective picked-up images is not rectangular. Accordingly, the panorama combining unit 212 cuts out the largest rectangular region PL21 inscribed in the region of the entire image obtained by connecting the strip-like region RE11 to the strip-like region RE17 and sets such region PL21 as the panorama image. At this time, the long edge of the rectangular region PL21 is set so as to be parallel to the sweep axis. By carrying out trimming in this way, it is possible to obtain a rectangular panorama image with a favorable appearance.

Returning to the description of the flowchart in FIG. 22, when the panorama image has been generated and outputted, the global motion vector calculating process ends.

As described above, the image pickup apparatus 11 calculates the global motion vectors of the picked-up images, cuts out strip-like regions from the picked-up images using the obtained global motion vectors, and generates a panorama image.

Note that the generation of the panorama image may be carried out after calculating the global motion vectors of the picked-up images of every frame or the calculation of the global motion vectors and the generation of the panorama image may be carried out in parallel.

### Seventh Embodiment

### Configuration of Image Processing Circuit

Although a case where the calculated global motion vectors are used in the generation of a panorama image has been described above, the calculated global motion vectors may be used in image stabilization during the image pickup of moving images, for example.

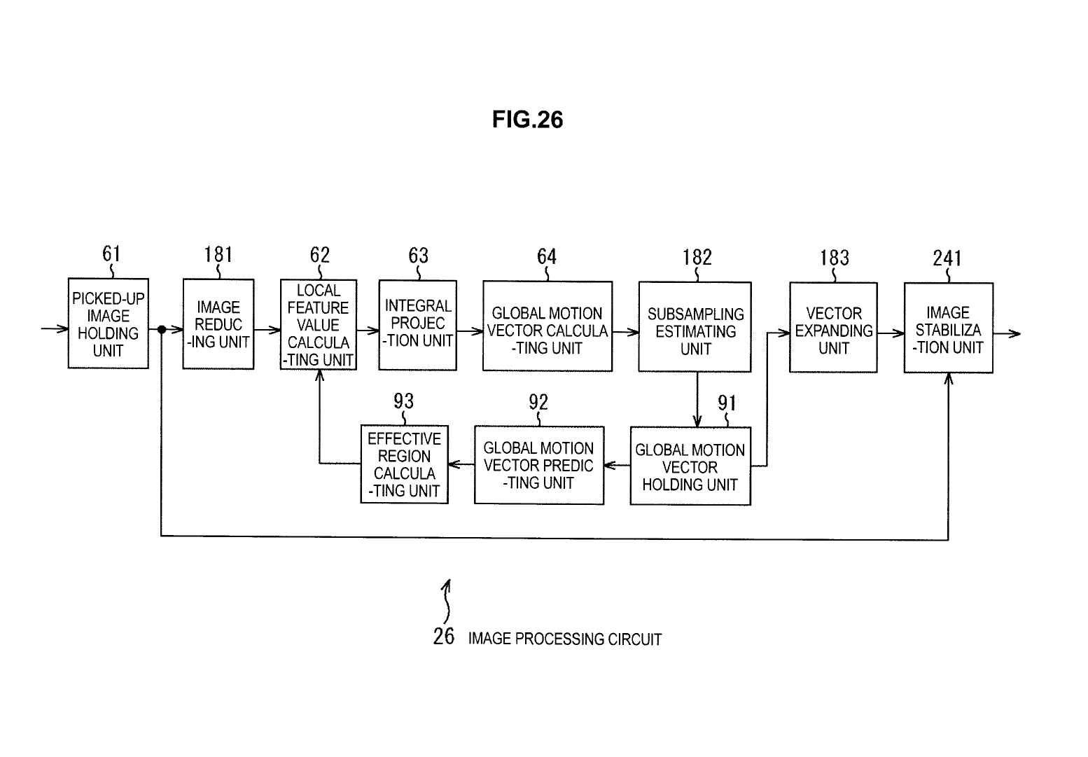

In such case, the image processing circuit 26 in FIG. 3 is configured as shown in FIG. 26. Note that parts in FIG. 26 that are the same as in FIG. 21 have been assigned the same reference numerals and description thereof is omitted as appropriate.

The image processing circuit 26 in FIG. 26 includes the picked-up image holding unit 61, the image reducing unit 181, the local feature value calculating unit 62, the integral projection unit 63, the global motion vector calculating unit 64, the subsampling estimating unit 182, the global motion vector holding unit 91, the vector expanding unit 183, the global motion vector predicting unit 92, the effective region calculating unit 93, and an image stabilization unit 241.

The configuration of the image processing circuit 26 in FIG. 26 differs to the image processing circuit 26 in FIG. 21 by newly including the image stabilization unit 241 in place of the strip-like region calculating unit 211 and the panorama combining unit 212 in FIG. 21 and otherwise is the same as the image processing circuit 26 in FIG. 21.

The image stabilization unit 241 carries out image stabilization on the picked-up images based on the picked-up images supplied from the picked-up image holding unit 61 and the global motion vectors supplied from the vector expanding unit 183 and outputs the picked-up images obtained as a result.

### Description of Global Motion Vector Calculating Process

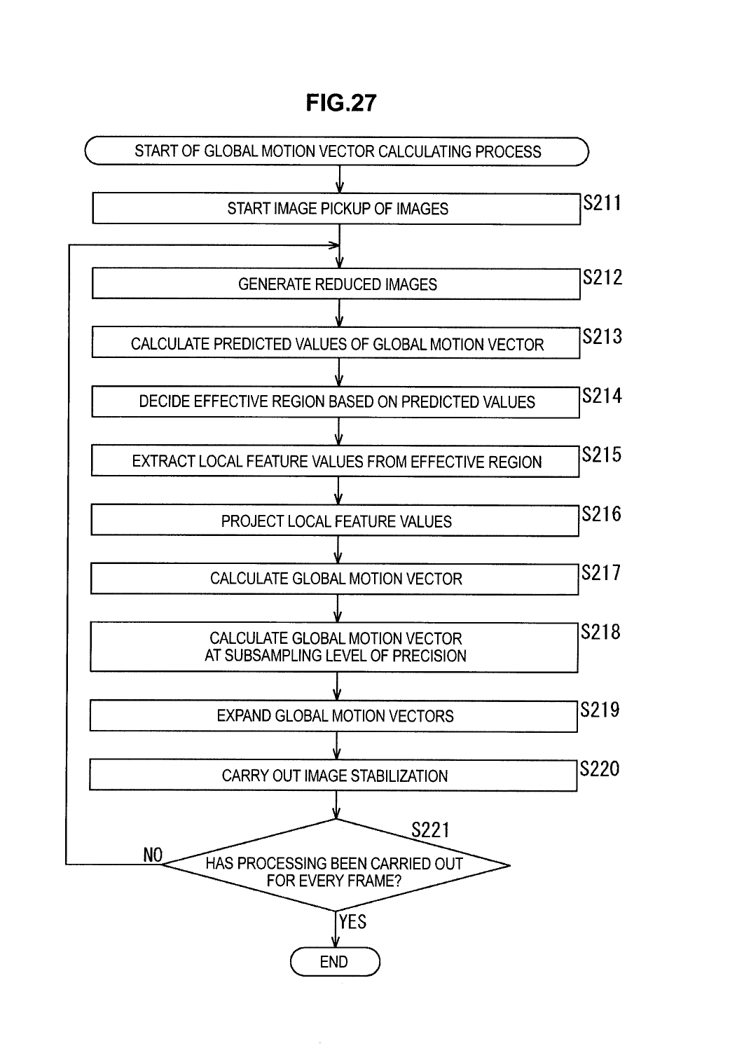

Next, the global motion vector calculating process for a case where the image processing circuit 26 of the image pickup apparatus 11 is configured as shown in FIG. 26 will be described with reference to the flowchart in FIG. 27. Note that since the processing in step S211 to step S219 is the same as the processing in step S171 to step S179 in FIG. 22, description thereof is omitted.

In step S220, the image stabilization unit 241 carries out image stabilization on the picked-up images based on the picked-up images supplied from the picked-up image holding unit 61 and the global motion vectors supplied from the vector expanding unit 183 and outputs the picked-up images obtained as a result. As one example, by projecting the picked-up images onto a normal coordinate system using the global motion vectors so that camera shake components are cancelled out, the image stabilization unit 241 removes the camera shake components from the picked-up images. In this example, a global motion vector is a vector showing camera shake during image pickup.

In step S221, the image processing circuit 26 determines whether processing has been carried out for the picked-up images of every frame. For example, when image stabilization has been carried out for the picked-up image of every frame, it is determined that processing has been carried out for every frame.

If it is determined in step S221 that processing has not been carried out for every frame, the processing returns to step S212 and the processing described above is repeated. On the other hand, if it is determined in step S221 that processing has been carried out for every frame, the image processing circuit 26 stops the processing of the respective units and the global motion vector calculating process ends.

In this way, the image pickup apparatus 11 calculates global motion vectors of picked-up images and removes the camera shake components from the picked-up images using the obtained global motion vectors.

As described above, with the image pickup apparatus 11 according to the embodiments of the present disclosure, it is possible to calculate global motion vectors precisely and at high speed.

For example, if a panorama image is generated by combining a plurality of picked-up images, the global motion vectors of the picked-up images are factors that greatly contribute to the image quality and calculation cost of the final panorama image. However, with an existing global motion vector calculating method, it was not possible to achieve both a low calculation cost and high calculation precision.

On the other hand, according to the image pickup apparatus 11, the number of dimensions of the search region for the feature values during the matching process is reduced by projecting the local feature values, thereby realizing a low calculation cost. More specifically, with the image pickup apparatus 11, the search region for the feature values is reduced from being two-dimensional to being one dimensional in each of two directions.

Also, if the region used to extract the local feature values is limited using a region of excluded subjects and/or the lens distortion information, it is possible to eliminate one factor that can adversely affect the calculation precision of the global motion vectors. That is, by excluding a subject that is only present in the picked-up image of one frame and/or a region where image distortion is produced by the lens from the region to be processed, it is possible to reduce the calculation cost and also to further improve the calculation precision of the global motion vectors.

As described above, according to the image pickup apparatus 11, it is possible to calculate global motion vectors while achieving both a low calculation cost and a high calculation precision. Also, by using this technology, it is possible, even in a device, such as a digital camera or a mobile terminal appliance, which has low processing performance compared to a personal computer or the like, to carry out panorama image combining at high speed and with high quality, for example. In addition, it is also possible to carry out image stabilization during image pickup or reproduction of moving images.

Note that the series of processing described above can be executed by hardware and can also be executed by software. If the series of processing is executed by software, a program that constructs the software is installed from a program recording medium into a computer incorporated in dedicated hardware or a general-purpose personal computer or the like which is capable of executing various functions by having various programs installed.

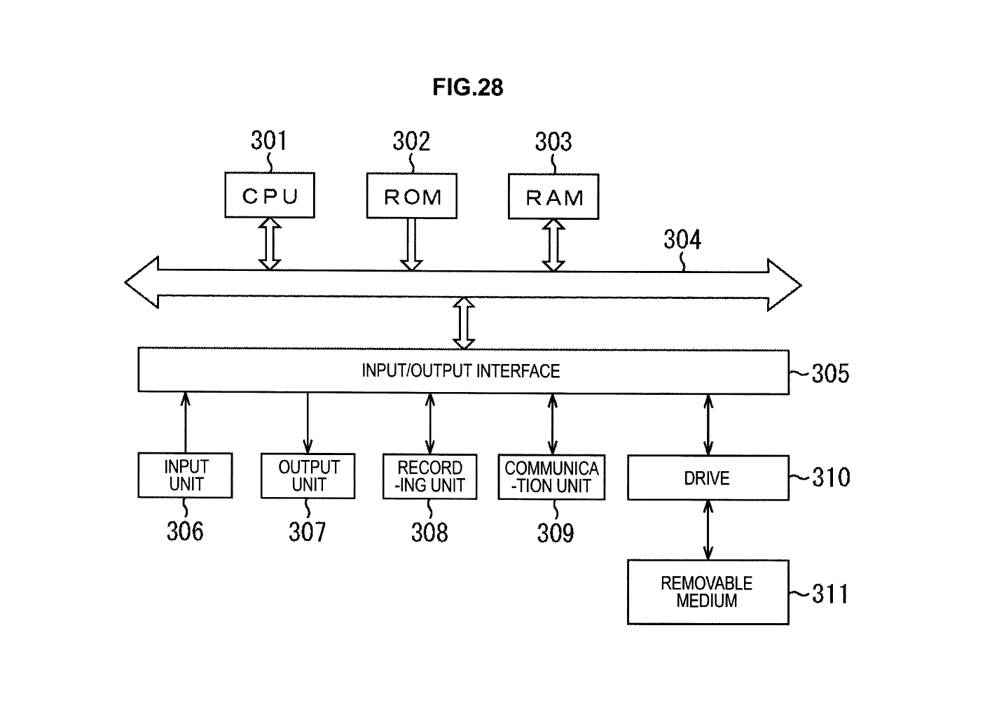

FIG. 28 is a block diagram showing an example hardware configuration of a computer that executes the series of processing described earlier according to a program.

In this computer, a CPU (Central Processing Unit) 301, a ROM (Read Only Memory) 302, and a RAM (Random Access Memory) 303 are connected to one another by a bus 304.

An input/output interface 305 is also connected to the bus 304. An input unit 306 composed of a keyboard, a mouse, a microphone, or the like, an output unit 307 composed of a display, speakers, and the like, a recording unit 308 composed of a hard disk drive, a nonvolatile memory, or the like, a communication unit 309 composed of a network interface or the like, and a drive 310 that drives a removable medium 311 such as a magnetic disk, an optical disc, a magneto-optical disc, or a semiconductor memory are connected to the input/output interface 305.

In the computer configured as described above, as one example the CPU 301 loads a program recorded in the recording unit 308 via the input/output interface 305 and the bus 304 into the RAM 303 and executes the program to carry out the series of processing described earlier.

The program executed by the computer (CPU 301) is recorded on a removable medium 311 that is a packaged medium composed for example of a magnetic disk (including a flexible disk), an optical disc (such as a CD-ROM (Compact Disc-Read Only Memory) or a DVD (Digital Versatile Disc)), a magneto-optical disc, or a semiconductor memory, or is provided via a wired or wireless transfer medium such as a local area network, the Internet, or a digital satellite broadcast.

After this, by loading the removable medium 311 into the drive 310, the program can be installed via the input/output interface 305 into the recording unit 308. It is also possible to receive the program via a wired or wireless transfer medium using the communication unit 309 and install the program into the recording unit 308. As an alternative, it is also possible to install the program in advance into the ROM 302 or the recording unit 308.

It should be noted that the program executed by a computer may be a program that is processed in a time series according to the sequence described in this specification or a program that is processed in parallel or at necessary timing such as upon calling.

The configuration of the present disclosure has been described in detail above with reference to specific embodiments.

Additionally, the present technology may also be configured as below.

[1] An image processing apparatus including:

a predicting unit calculating, based on a global motion vector found for a past picked-up image, predicted values of a global motion vector of a picked-up image to be processed;

an effective region calculating unit deciding an effective region on the picked-up image based on the predicted values;

a feature value calculating unit extracting feature values from the effective region on the picked-up image;

a projecting unit calculating projected feature vectors by projecting the feature values onto an axis in a specified direction; and

a global motion vector calculating unit calculating a global motion vector of the picked-up image to be processed by matching the projected feature vectors of the picked-up image to be processed and projected feature vectors of another picked-up image.

[2] An image processing apparatus according to [1],

wherein the effective region calculating unit decides the effective region based on the predicted values and one of distortion information for an optical system used to pick up the picked-up images and a region of a specified subject in the picked-up images.

[3] An image processing apparatus according to [1] or [2],

wherein the feature value calculating unit calculates the feature values based on pixels aligned in the specified direction on the picked-up images.

[4] An image processing apparatus according to any one of [1] to [3],

wherein the feature value calculating unit calculates the feature values based on gradient information of pixels in the picked-up images.

[5] An image processing apparatus according to [1] or [2],

wherein the feature value calculating unit calculates the feature values based on color information of the picked-up images.

[6] An image processing apparatus according to any one of [1] to [5],

wherein the projecting unit projects the feature values onto two axes that are respectively perpendicular and calculates the projected feature vectors for each axis.

[7] An image processing apparatus according to any one of [1] to [6],

further comprising a panorama combining unit combining the picked-up images based on the global motion vectors to generate a panorama image.

[8] An image processing apparatus according to any one of [1] to [6],

further comprising an image stabilization unit carrying out image stabilization on the picked-up images based on the global motion vector.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-154627 filed in the Japan Patent Office on Jul. 13, 2011, the entire content of which is hereby incorporated by reference.

What is claimed is:

1. An image processing apparatus comprising:
a predicting unit calculating, based on a global motion vector found for a past picked-up image, predicted values of a global motion vector of a picked-up image to be processed;
an effective region calculating unit deciding an effective region on the picked-up image based on the predicted values;
a feature value calculating unit extracting feature values from the effective region on the picked-up image;
a projecting unit calculating projected feature vectors by projecting the feature values onto an axis in a specified direction; and
a global motion vector calculating unit calculating a global motion vector of the picked-up image to be processed by matching the projected feature vectors of the picked-up image to be processed and projected feature vectors of another picked-up image.

2. An image processing apparatus according to claim 1,
wherein the effective region calculating unit decides the effective region based on the predicted values and one of distortion information for an optical system used to pick up the picked-up images and a region of a specified subject in the picked-up images.

3. An image processing apparatus according to claim 2,
wherein the feature value calculating unit calculates the feature values based on pixels aligned in the specified direction on the picked-up images.

4. An image processing apparatus according to claim 3,
wherein the feature value calculating unit calculates the feature values based on gradient information of pixels in the picked-up images.

5. An image processing apparatus according to claim 2,
wherein the feature value calculating unit calculates the feature values based on color information of the picked-up images.

6. An image processing apparatus according to claim 1,
wherein the projecting unit projects the feature values onto two axes that are respectively perpendicular and calculates the projected feature vectors for each axis.

7. An image processing apparatus according to claim 1,
further comprising a panorama combining unit combining the picked-up images based on the global motion vectors to generate a panorama image.

8. An image processing apparatus according to claim 1,
further comprising an image stabilization unit carrying out image stabilization on the picked-up images based on the global motion vector.

9. An image processing method of an image processing apparatus including a predicting unit calculating, based on a global motion vector found for a past picked-up image, predicted values of a global motion vector of a picked-up image to be processed, an effective region calculating unit deciding an effective region on the picked-up image based on the predicted values, a feature value calculating unit extracting feature values from the effective region on the picked-up image, a projecting unit calculating projected feature vectors by projecting the feature values onto an axis in a specified direction, and a global motion vector calculating unit calculating a global motion vector of the picked-up image to be processed by matching the projected feature vectors of the picked-up image to be processed and projected feature vectors of another picked-up image,
the image processing method comprising:
the predicting unit calculating the predicted values;
the effective region calculating unit deciding the effective region;
the feature value calculating unit extracting the feature values;
the projecting unit calculating the projected feature vectors; and
the global motion vector calculating unit calculating the global motion vector.

10. A program causing a computer to carry out processing comprising:
calculating, based on a global motion vector found for a past picked-up image, predicted values of a global motion vector of a picked-up image to be processed;
deciding an effective region on the picked-up images based on the predicted values;
extracting feature values from the effective region on the picked-up images;
calculating projected feature vectors by projecting the feature values onto an axis in a specified direction; and
calculating a global motion vector of the picked-up image to be processed by matching the projected feature vectors of the picked-up image to be processed and projected feature vectors of another picked-up image.

11. An image processing apparatus comprising:
an effective region calculating unit deciding an effective region on a picked-up image based on one of distortion information for an optical system used to pick up the picked-up image and a region of a specified subject in the picked-up image;
a feature value calculating unit extracting feature values from the effective region on the picked-up image;
a projecting unit calculating projected feature vectors by projecting the feature values onto an axis in a specified direction; and
a global motion vector calculating unit calculating a global motion vector of the picked-up image to be processed by matching the projected feature vectors of the picked-up image to be processed and projected feature vectors of another picked-up image.

12. An image processing method of an image processing apparatus including an effective region calculating unit deciding an effective region on a picked-up image based on one of distortion information for an optical system used to pick up the picked-up image and a region of a specified subject in the picked-up image; a feature value calculating unit extracting feature values from the effective region on the picked-up image; a projecting unit calculating projected feature vectors by projecting the feature values onto an axis in a specified direction; and a global motion vector calculating unit calculating a global motion vector of the picked-up image to be processed by matching the projected feature vectors of the picked-up image to be processed and projected feature vectors of another picked-up image, the image processing method comprising:
the effective region calculating unit deciding the effective region;
the feature value calculating unit extracting the feature values;
the projecting unit calculating the projected feature vectors; and
the global motion vector calculating unit calculating the global motion vector.

13. A program causing a computer to carry out processing comprising:
deciding an effective region on a picked-up image based on one of distortion information for an optical system used to pick up the picked-up image and a region of a specified subject in the picked-up image;
extracting feature values from the effective region on the picked-up image;
calculating projected feature vectors by projecting the feature values onto an axis in a specified direction; and
calculating a global motion vector of the picked-up image to be processed by matching the projected feature vectors of the picked-up image to be processed and projected feature vectors of another picked-up image.
